(19) United States
(12) Patent Application Publication
(10) Pub. No.: US 2025/0010117 A1
(43) Pub. Date: Jan. 9, 2025

(54) Fluorine Free Surfactants and Foam Composition

(71) Applicants: Robert Valentine Kasowski, west chester, PA (US); Seminara Hahnah Kasowski, Bronxville, NY (US)

(72) Inventors: Robert Valentine Kasowski, west chester, PA (US); Seminara Hahnah Kasowski, Bronxville, NY (US)

(21) Appl. No.: 18/289,364

(22) PCT Filed: Jul. 27, 2022
(86) PCT No.: PCT/US2022/038592

§ 371 Date: Sep. 27, 2024

(51) Int. Cl. A62D 1/02

(52) U.S. Cl. CPC A62D 1/0071

(57) ABSTRACT

An alternative is needed for replacing aqueous film forming foams (AFFF) containing fluorine. The ethyleneamine salt of a chemical precursor solution has been made that is a surfactant with both foaming properties and flame retardant properties. The chemical precursor solution is formed by reacting a complex alkyl compound with sulfuric or polyphosphoric acid. The resultant foam made with this surfactant is applied with a large footprint to overcome poor spreading coefficient and is successful in extinguishing fuel fires.

### FIELD OF INVENTION

Fluorine free foam has been made by forming a surfactant with flame retardant properties. This surfactant mixed with water forms foam with expansion ratios higher than 5. The foams are effective in extinguishing gasoline tank fires especially if applied as a mist with a large footprint. This foam reacts with the gasoline flames as intumescent char is observed on the surface of the tank after the fire is put out.

### BACKGROUND OF INVENTION

Aqueous film forming foams (AFFF) are water-based and frequently contain hydrocarbon-based surfactant such as sodium alkyl sulfates and fluorosurfactants, such as fluorotelomers, perfluorooctanoic acid (PFOA), or perfluorooctanesulfonic acid (PFOS). Perfluorooctanoic acid—also known as C8 or C6—is a perfluorinated carboxylic acid produced and used worldwide as an industrial surfactant in chemical processes. These fire fighting foams have been the preferred method for application to flammable liquid fires. Fluorine free foams often using surfactants such as sodium alkyl sulfate are less effective. However, it became clear that per fluorinated compounds such as PFOS and PFOA are extremely persistent in the environment, and toxicological studies have linked the chemicals to serious negative effects on human health. Their use in the EU has been restricted since 2006 and the Stockholm Convention listed PFOS and its related substances as persistent organic pollutants that are to be phased out. A further restriction on the manufacture, use and marketing of PFOA and its related substances, under REACH, was also adopted in 2017 by the European Commission.

There is a growing body of scientific evidence that PFCs may be toxic to humans and to ecosystems. Some PFCs (PFOS and PFOA) are being phased out because of concerns about their safety. Many companies list only “proprietary fluorosurfactants mixtures” as ingredients in fire fighting foams

A per fluorinated compound (PFC) per- or polyfluoroalkyl chemical is an organofluorine compound containing carbon-fluorine bonds and C—C bonds but also other heteroatoms. PFCs, also known as perfluorinated chemicals, have properties that represent a blend of fluorocarbons (containing only C—F and C—C bonds) and the parent functionalized organic species. For example, perfluorooctanoic acid functions as a carboxylic acid but with strongly altered surfactant and hydrophobic characteristics. Fluorosurfactants are ubiquitously used in Teflon, water resistant textiles and fire-fighting foam.

The presence of perfluorinated compounds (PFCs) in source waters and drinking water is of growing concern to water professionals. This group of organic compounds, used for industrial and consumer applications such as nonstick coatings and firefighting foams, has potential health implications for humans and wildlife. PFCs are extremely persistent. Researchers are finding serious health concerns about PFCs, including increased risk of cancer. PFOA is a likely human carcinogen; it causes liver, pancreatic, testicular, and mammary gland tumors in laboratory animals. PFOS's half-life is estimated at more than 8 years.

An alternative halogen free environmentally friendly fire fighting technology for application to flammable liquid fires is of need. A surfactant composition or surfactant solution with the properties of foaming agent and flame retardance has been made by making a new chemical precursor which is reacted with an ethyleneamine. This surfactant mixed with water, a thickening agent and organic solvent results in a fluorine free foam (FFF) that intumeses when subjected to a flame. This fluorine free foam (FFF) in the form of a mist or single stream can extinguish flammable liquid fires and class A fires. It will be shown that foam in the form of a mist can be applied with a boom to have a large footprint and more easily extinguish a flammable liquid fire than standard technology of a single stream.

### SUMMARY

To form a FFF, the first step is to form a chemical precursor solution, comprising a chemical precursor solution 1 and a chemical precursor solution 2, wherein the chemical precursor solution 1 is formed by a reaction of a complex alkyl compound with an acid chosen from a group comprising polyphosphoric acid (PPA), phosphoric acid, sulfuric acid, and sulfonic acid, and a ratio by weight of the complex alkyl compound to the acid is at least 0.01 but less than 20; the chemical precursor solution 2 is formed by a reaction of complex alkyl sulfate ester or complex alkyl phosphate ester with the polyphosphoric acid, and a ratio by weight of the complex alkyl sulfate ester or the complex alkyl phosphate ester to the polyphosphoric acid is at least 0.01 but less than 20; and the complex alkyl compound is chosen from a group comprising ethoxylated fatty alcohols, fatty alcohols, alcohols, ethoxylated alcohols, ethoxylated phenol, ethoxylated alkylphenol, alkyl polyglycoside, and alkyl aryl. It is preferred that the reaction to form the chemical precursor solution is performed at a temperature between room temperature to 400° F., the polyphosphoric acid has a grade from 105% to 118%, concentrations of the phosphoric acid and the sulfuric acid are each at least 80%, and 10% by weight chemical precursor solution in water has a pH of less than 2.2.

A surfactant composition is formed by the reaction of one or more compounds chosen from a group comprising ethyleneamine, alkali metals, ammonia, and alkanolamines with 1) one or more of the chemical precursor solutions 1 and 2, and 2) with one or more compounds chosen from a group comprising complex alkyl phosphate ester, complex alkyl sulfate ester, and complex alkyl sulfonate ester, and 10% of the surfactant composition in water or in water and organic solvent has a pH of at least 3.5 and less than 8.5.

A surfactant solution is formed 1) by dissolving the surfactant composition in water or in mixed water and organic solvent, or 2) by dissolving the chemical precursor solution in water or in mixed water and organic solvent and then reacting the chemical precursor solution 1 or the chemical precursor solution 2 with one or more compounds chosen from a group comprising ethyleneamine, alkali metals, ammonia, and alkanolamines with a concentration of a resulting solution being at least 1% by weight of the surfactant solution. The surfactant solution and the surfactant composition both have the property of flame retardance if the chemical precursor is made with phosphoric acid, polyphosphoric acid, or sulfuric acid and reacted with ethyleneamine. Polyphosphoric is preferred due to having more self intumescence.

A fluorine free foam (FFF) composition is formed from water and the surfactant solution. Thickening agents, other surfactants, and organic solvents can be added.

### DETAILED DESCRIPTION

Foam compositions primarily are comprised of water, organic solvent, surfactants, and thickening agent. Furthermore, organic solvent may mean one or more organic solvents, surfactant may mean one or more surfactants, and thickening agent may mean one or more thickening agents. The terms complex alkyl and complex alkyl compound are used interchangeably. The terms complex alkyl phosphate and complex alkyl phosphate solution are used interchangeably. The terms complex alkyl polyphosphate and complex alkyl polyphosphate solution are used interchangeably. The terms complex alkyl sulfate and complex alkyl sulfate ester are used interchangeably. The terms dodecyl and lauryl are interchangeable. A solution is a homogeneous mixture of two or more substances. A solution may exist in any phase. A solution consists of a solute and a solvent. The solute is the substance that is dissolved in the solvent. Flame retardants are chemicals that are applied to materials to prevent the start or slow the growth of fire. A foaming agent is a material that facilitates the formation of foam such as a surfactant. Wetting agent is a chemical that can be added to a liquid to reduce its surface tension and make it more effective in spreading over and penetrating surfaces. In chemistry, a precursor is a compound that participates in a chemical reaction that produces another compound. The measurement of pH of compositions will often be measured. The measurement will be 10% by weight of the composition in water unless specifically indicated otherwise. Compositions will be discussed and disclosed usually by %. It is always % by weight of composition and never by volume unless specifically indicated. Soluble means the ingredient will dissolve and merge with the substance it is put into. In short, it will become a homogenous mass. Dispersible means the ingredient doesn't merge with the substance it is put into, but it can be dispersed (spread out evenly) if handled according to a specific method. A hazy solution forms but no separation occurs.

The terms complex alkyl phosphate solution and complex alkyl polyphosphate solution are not interchangeable. The composition formed by mixing together complex alkyl phosphate solution and PPA and then reacting with an ethyleneamine is not interchangeable with mixing or melting together ethyleneamine complex alkyl phosphate solution and EAPPA. The term ester has a specific meaning in chemistry. The term complex alkyl phosphate ester (CAPE) has a structure consistent with this definition with monoester and diester bonds. The term complex alkyl polyphosphate solution here refers to the compound formed by reacting a complex alkyl compound and polyphosphoric acid over a wide range of ratios. The exact nature of the chemical bonding is not known. The term complex alkyl phosphate solution here refers to the compound formed by reacting a complex alkyl compound and phosphoric acid over a wide range of ratios. The exact nature of the chemical bonding is not known.

Ethyleneamine polyphosphate (EAPPA) is formed by direct reaction of ethyleneamine (EA) and polyphosphoric acid (PPA) near the theoretical acid base ratio with the reaction performed without water or other solvent. This form of EAPPA can be made by reacting any grade of PPA including PPA subjected to condensation. The synthesis without a dopant is detailed in U.S. Pat. No. 10,501,602. Synthesis with dopants such as fumed silica is covered in PCT/19/034077. It was not disclosed in either reference that such aqueous compositions containing hydrophilic fumed silica promote adhesion and suppress dripping from surfaces which is most helpful in the application of these solutions to extinguishing fires. The synthesis of flame-retardants using polyphosphoric acid is disclosed in U.S. Pat. Nos. 7,138,443, 8,212,073; WO 2011/049615 (PCT/US12/000247), PCT/US2003/017268, and U.S. Pat. No. 8,703,853. Fluorine free foam is disclosed in U.S. Pat. No. 7,569,155 and is prior art. Formation of mist and foam with EAPPA solutions is disclosed in PCT/US20/52061. The provisional applications and date of filing are 63 331795 (16 Apr. 2022), 63 305650 (1 Feb. 2022), 63 277466 (9 Nov. 2021), 63 226717 (28 Jul. 2021). The entire disclosure is incorporated herein by reference. FS can be added to PPA before synthesis of EAPPA. FS can be added directly to aqueous solutions after synthesis. It is preferred to make EAPPA and then dilute with water to desired concentration. It is also possible but less preferred to dilute the polyphosphoric acid with water and then add ethyleneamine to make the desired product. The most preferred EAPPA is made with PPA and the following ethyleneamines: ethylenediamine (EDA), diethylenetriamine (DETA), piperazine (PIP), triethylenetetramine (TETA), tetraethylenepentamine (TEPA), and pentaethylenehexamine (PEHA).

No references have been found of efforts to form compounds with flame retardant properties and surfactant properties. No references have been found of efforts to form fluorine free fire fighting foams with compounds having both surfactant and flame retardant properties. Alkali metal salts are not known to have flame retardant properties. Amine salts of phosphates are well known in flame retarding polymers. Amine salts of sulfates not known for flame retarding polymers to our knowledge.

Ethyleneamines are defined here as ethylene diamine and polymeric forms of ethylene diamine including piperazine and its analogues. A thorough review of ethyleneamines can be found in the Encyclopedia of Chemical Technology, Vol 8, pgs. 74-108. Ethyleneamines encompass a wide range of multifunctional, multi reactive compounds. The molecular structure can be linear, branched, cyclic, or combinations of these. Examples of commercial ethyleneamines are ethylenediamine (EDA), diethylenetriamine (DETA), piperazine (PIP), triethylenetetramine (TETA), tetraethylenepentamine (TEPA), and pentaethylenehexamine (PEHA). Other ethyleneamine compounds which are part of the general term ethyleneamine (EA) which may be applicable are, aminoethylenepiperazine (EAP), 1,2-propylenediamine, 1,3-diaminopropane, iminobispropylamine, N-(2-aminoethyl)-1,3-propylenediamine, N,N′-bis-(3-aminopropyl)-ethylenediamine, dimethylaminopropylamine, and triethylenediamine. Ethyleneamine polyphosphate can be formed with any of these ethyleneamine.

Alkanolamines are chemical compounds that contain both hydroxyl (—OH) and amino (—NH2, —NHR, and —NR2) functional groups on an alkane backbone such as for example, triethanolamine (TEA) and 2-amino-2-methyl-1-propanol (AMP).

Polyphosphoric acid (PPA) is an oligomer of H3PO4. High purity PPA is produced either from the dehydration of H3PO4 at high temperatures or by heating P2O5 dispersed in H3PO4. The equilibrium for these reactions produces different chains lengths and distributions. The dehydration method tends to produce short chains, whereas the dispersion method usually produces chains with more than 10 repeat units, which are more preferable in making the compositions of this invention. Many different temperatures are used in the reaction of P2O5 and 85% concentration phosphoric acid in making PPA.

PPA is available in various grades, the naming of which can be confusing as the percentage can exceed 100%. One hundred percent phosphoric acid contains 72.4% P2O5 as calculated from the formula weight ratio P2O5/H3PO4. Similarly, Pyrophosphoric acid (H4P2O7) contains 79.8% P2O5 as calculated from the ratio P2O5/H4P2O7. The ratio of these P2O5 contents provides a relative phosphoric acid content, which for pyrophosphoric acid is 79.8%/72.4%=110%. Due to high viscosity, PPA is difficult to pour and stir at room temperature, but is much easier to work with at temperatures above 60° C.

The production of PPA provides a distribution of chain lengths, where the number of repeat units in the PPA chain n, varies from one chain to the next. The 105% PA grade from Innophos Corp. contains for the most part short monomeric and dimeric segments, ortho (54%), pyrophosphoric (41%) and 5% triphosphoric and pours easily and would not be expected to provide a route to high molecular weight EAPPA. In the higher 115% grade, little monomer is left as most of the chain lengths are 2-14 units long. This increase in chain length leads to chain entanglements and explains the increased viscosity of the higher grades. The 117% grade contains (3% Ortho, 9% pyro, 10% tri, 11% tetra, 67% higher acids) The 115% grade contains (5% ortho, 16% pyro, 17% tri, 16% tetra, 46% higher). They are from Innophos, Trenton, NJ. All grades of PPA are claimed regardless of how formed.

Polyphosphoric acid available commercially contains some ortho phosphoric acid as well as pyrophosphoric acid. By subjecting polyphosphoric acid to by heating and applying vacuum simultaneously, the amount of ortho phosphoric acid and low molecular weight PPA can be reduced substantially and a more viscous polyphosphoric acid results with much higher molecular weight. Condensed polyphosphoric acid and commercially available polyphosphoric acids are included together as polyphosphoric acids.

EAPPA has been made directly by the reaction of ethyleneamine with polyphosphoric acid and with the ratio of PPA to ethyleneamine chosen so that the pH of a 10% aqueous solution by weight of the resulting composition is at least 2.7. It is preferred that the pH is at least 3.5. More preferred are 4.2. Most preferred is pH greater than or equal to 5.0.

Alkyl polyglycosoide is a biodegradable ingredient derived from plant starch and fatty alcohol from coconuts. Alkyl phosphates belong to a group of organic compounds called organophosphates. They are esters of phosphoric acid H3PO4 and corresponding alcohol. Ethoxylated alkyl phosphates are formed with ethoxylated alcohols.

A gel is a semi-solid that can have properties ranging from soft and weak to hard and tough. Gels are defined as a substantially dilute cross-linked system, which exhibits no flow when in the steady-state.

Intumescense of a coating, as used in the context of this specification, is the swelling up when heated or subjected to flames, thus protecting the material underneath in the event of a fire. Fire resistant paints typically contain ammonium polyphosphate, pentaerythritol, dipentaerythritol, and melamine and a binder such as vinyl acetate copolymers. When subjected to heat or flame, the coating becomes a light char or micro porous carbonaceous foam due to chemical reaction of three main components. The identifying unique characteristic of ethyleneamine polyphosphates is that these compounds intumescence from heat or flames, with no need for melamine or pentaerythritol. This property is referred to as self intumescence.

Mist applies to a condition where water is held in suspension in fine particles in the air, floating or slowly falling in minute drops. Vapors are composed of single, gas-phase molecules whereas mist droplets are liquid-phase and contain thousands or millions of molecules. Common examples of mist are spray cans, clouds and fog where mist droplets are very small. Their mean diameter is typically only 10-15 micron (1 micron= 1/1000 mm) but in any one cloud the individual drops range greatly in size from 1 to 100 micron dia. Haze, mist, fog, and smog denote an atmospheric condition which deprives the air near the earth of its transparency. Steam is the vapor into which water is converted when heated, forming a white mist of minute water droplets in the air.

Mist is defined here as a cloud of tiny droplets of fire extinguishing solution. Mist is not a very distinct term except that it is formed of tiny droplets and the visibility is reduced depending on droplet size and density. Droplet sizes are measured in microns. A micron is 1/1000 millimeter (micrometer), or about 1/25,000 of an inch. For perspective, a human hair is about 100 microns in diameter. Spray droplets smaller than 150 microns tend to be prone to drift. High pressure such as 4000 PSI will overcome mild drift problems.

In PCT/US20/52061, it is stated “that it is necessary to form a mist for EAPPA solutions to be effective for direct application to the flames of any type of fire. The dimension of the droplets within the mist is also of critical importance. Volume Median Diameter (VMD) refers to the midpoint droplet size (median), where half of the volume of spray is in droplets smaller, and half of the volume is in droplets larger than the median. If the droplets are large, the spray is far less effective. The efficiency of extinguishing a fire increases rapidly as the droplet size is reduced.” Here, foam in the form of a mist will be shown to be effective and with the same equipment.

In agriculture, there exists equipment with which to spray aqueous solutions in the form of a mist. The droplet size within a mist is defined by VMD. Extremely fine has the code XF and droplet size less than 60 micron. Very fine is VF and droplet size 60-145 micron. Fine is F and droplet size 145-225 microns. Medium is M and size 226-325 microns. Coarse is C and droplet size 326-400 microns. Very coarse is VC and droplet size 401-500 microns. EC is extremely coarse and droplet size 501-650. Ultra course is UC and droplet size greater than 650 micron.

For our purposes, a droplet size of 1500 microns or less is claimed, or less than 600 micron is preferred, or less than 400 micron is more preferred, or less than 200 micron is even more preferred, or less than 75 microns is most preferred for formation of a mist of fire extinguishing liquid or fire extinguishing foam when projected thru a nozzle with a tiny hole by pressure. The nozzle can cause the mist to have a variety of shapes and droplet sizes. We exclude the use of a continuous stream of liquid from a large hose or from dropping of liquid from an aircraft. In agriculture, drift, plant coverage, penetration of plant foliage and delivery equipment is carefully considered in choosing the right nozzle to obtain the best droplet size for chemicals applied to soil and plants.

Aqueous solutions of EAPPA made with ethyleneamine and referred to as PNS. All examples of PNS were made using PPA grade 115% reacted with DETA. It is also possible to dilute PPA with water and then add EA to form an aqueous form of EAPPA although this method is not preferred. The water breaks down the molecular weight especially with temperature so that the solution is a polymer of lower molecular weight and no free water. The solutions reported in the examples are made by diluting PNS made with PPA 115% and DETA. Such examples could be made directly by using PPA comparable to that grade of PPA. We use this high molecular weight method as solids tend to minimize cost, storage, and transportation problems. The solid is converted to PNS solution when needed. Compounds made by mixing together PPA and one or more complex alkyl compounds and then reacted with EA have both flame retardant properties and surfactant properties and called PNS-F.

A radical is a chemical species that contains an unpaired electron. In general, radicals are highly reactive and form new bonds again very quickly. A radical may be electrically neutral, positively charged (radical cation) or negatively charged (radical anion). An ion carries a charge that means that the number of electrons and protons do not match. Electrons have a negative charge and protons have a positive charge. Ions will seek the opposite charge to become neutral.

At a certain point in the combustion reaction, called the ignition point, flames are produced. The flame is the visible portion of the fire. If hot enough, the gases may become ionized to produce plasma. A flame (from Latin flamma) is the visible, gaseous part of a fire. It is caused by a highly exothermic reaction taking place in a thin zone. Very hot flames are hot enough to have ionized gaseous components of sufficient density to be considered plasma. The high temperature of the flame causes the vaporized fuel molecules to decompose, forming various incomplete combustion products and free radicals, and these products then react with each other. Sufficient energy in the flame will excite the electrons in some of the transient reaction intermediates such as the methylidyne radical (CH) and diatomic carbon (C₂), which results in the emission of visible light as these substances release their excess energy. As the combustion temperature of a flame increases (if the flame contains small particles of unburnt carbon or other material), so does the average energy of the electromagnetic radiation given off by the flame. The chemical kinetics occurring in the flame is very complex and typically involves a large number of chemical reactions and intermediate species, most of them radicals A fire is an example of a chemical chain reaction. A burning candle or other fire is an example of a chemical chain reaction.

The fire point of a fuel is the lowest temperature at which the vapor of that fuel will continue to burn for at least 5 seconds after ignition by an open flame of standard dimension. At the flash point, a lower temperature, a substance will ignite briefly, but vapor might not be produced at a rate to sustain the fire. The flash point is an important concept in fire investigation and fire protection because it is the lowest temperature at which a risk of fire exists with a given liquid. The flash point for gasoline is about −45° F., for diesel it is 126-205° F., for heptane it is 25° F. Thus, gasoline fires are much more dangerous than diesel fires.

Vapor pressure is the pressure caused by the evaporation of liquids. Three common factors that influence vapor press are surface area, intermolecular forces and temperature. The vapor pressure of a molecule differs at different temperatures. The most common measure of vapor pressure for gasoline is Reid vapor pressure (RVP). This is the pressure, in psi (pounds per square inch) or kPa (KiloPascals), necessary to keep a liquid from vaporizing when at 100° F. (37.8° C.). The RVP for gasoline is 7.8 to 16 PSI, a lot of vapors are being formed. Diesel has RVP is far lower at 0.03 to 0.1 PSI, very few vapors. Heptane has a RVP of about 1 PSI, nearly the same as water, intermediate vapors. Jet fuel RVP is about 0.21 PSI, very few vapors. Thus, gasoline is easy to ignite even at very low temperatures making it very easy to ignite as compared to diesel or jet fuel. From the flash point and Reid vapor pressure, it is very significant that EAPPA technology is able to extinguish gasoline fires.

Nozzles break the liquid into droplets, form the spray pattern, and propel the drops in the proper direction. Most common nozzles are flat, flood, air induction, hollow-cone, full-cone, and others. Flat fan nozzles are widely used for broadcast spraying of herbicides in a fan shape and are used in this specification. There are subtypes such as standard flat fan as used here, even flat fan, low pressure flat fan, extended range flat fan, twin orifice, and many more. It was unexpected that foam sprayed through these nozzles resulted in a mist of tiny foam droplets and that such mist has a high expansion ratio.

There are dozens of nozzles and hundreds of sizes and materials of construction. The simplest single fluid nozzle is a plain orifice nozzle. This nozzle often produces little if any atomization, but directs the stream of liquid. If the pressure drop is high, at least 25 bars (2,500 kPa, 363 PSI), the material is often finely atomized, as in a diesel injector. At lower pressures, this type of nozzle is often used for tank cleaning, either as a fixed position compound spray nozzle or as a rotary nozzle. Higher P decreases droplet size. Smaller nozzle also results in smaller droplets. Our FR foam technology works best if used as fine droplet size mist. For spraying water, a fourfold increase in pressure, results in double flow rate. The most common spray nozzles are flat fan, hollow cone, full cone, and streaming nozzles.

For flat fan spray nozzles, the shaped orifice uses a semispherical shaped inlet and a V notched outlet to cause the flow to spread out on the axis of the V notch. This nozzle is called a flat tip spray nozzle with a fan shaped spray. A flat fan spray pattern is useful for many spray applications, such as spray painting and agriculture spraying. Very tiny droplets really slow down when they leave the nozzle. Small droplets dry quickly loosing the water contribution. As the density of the liquid being sprayed increases, the spray angle decreases which are significant for spraying fire fighting solutions.

Most companies identify their flat-fan nozzles with a four or five digit number. The first numbers are the spray angle and the other numbers signify the discharge rate of water at rated pressure. For example, an 8005 has an 80 degree spray angle and will apply 0.5 gallons per minute (GPM) at rated pressure of 40 psi. An 8003 is used in this specification, which has 80 angle and 0.3 GPM at 40 psi for water. However the spray rates are different at different pressures and different liquids. A 8003 flat spray tip was hooked to the hose from a fire extinguisher tank containing water at 100 PSI. The spray rate was 0.51 GPM for the 8003 and 0.97 GPM for the 8006 at a 100 PSI significantly larger that at 40 PSI manufacturers data. For a pressure washer operating at 4000 PSI, the use of the both the 8003 and 8006 spray tips gives a spray rate for water of 2.3 GPM. The spray rate is the same if a Y connection is used to have two spray tips. It was unexpected that the flat tip spray rate for 4000 PSI pressure washer gave the same rate for spraying water.

It will turn out that hollow cone nozzles are more preferred over flat fan. Hollow cone nozzles give a smaller droplet size and smaller impact on the surface of fuel being applied to. A full discussion will come later in this specification.

Just as there are many types of nozzles, there are many types of sprayers. One of the most common forms of pesticide application, especially in conventional agriculture, is the use of mechanical sprayers. The size of droplets can be altered through the use of different nozzle sizes, or by altering the pressure under which it is forced, or a combination of both. Large droplets have the advantage of being less susceptible to spray drift, but require more water per unit of land covered. Due to static electricity, small droplets are able to maximize contact with a target organism, but very still wind conditions are required. Fog is a subclass of mist.

Even small changes in droplet diameter make big differences in droplet weight. An increase in droplet diameter from 150 microns to about 190 microns doubles the droplet weight. An increase in droplet diameter from 150 microns to about 240 microns increases the weight 4 times. Doubling the diameter to 300 microns increases its weight, and also its volume, by 8 times. Heavier droplets fall more quickly and are less affected by air movement.

Gasoline is not soluble in water. Gasoline is a complex mixture of non-polar compounds such as long chained hydrocarbons etc. Water is a polar molecule. The general solubility rule is that “like dissolves like”, meaning polar dissolves polar and non-polar dissolves non-polar.

Pressure washing is the use of high-pressure water spray to remove loose paint, mold, grime, dust, mud, chewing gum and dirt from surfaces and objects such as buildings, vehicles and concrete surfaces. A power washer uses a high-pressure stream of very hot water to blast away dirt and materials from outdoor surfaces. The volume of a mechanical pressure washer is expressed in gallons or liters per minute, often designed into the pump. The pressure, expressed in pounds per square inch, Pascals, or bar, is designed into the pump but can be varied by adjusting the unloader valve. Machines that produce pressures from 750 to 30,000 psi (5 to 200 MPa) or more are available. Ordinarily, the pressure washer takes in ordinary water from a garden hose, the pump accelerates the water to high pressure, and then squirts it from a hose at speed through a trigger gun that has a small outlet orifice compared to hose diameter. Usually, water comes out at 1550-3000 PSI. A pressure washer is primarily used for cleaning not for agriculture spray or firefighting.

It has been found that the preferred method to create very fine foam mist is with a modified pressure washer (1500 PSI to 4000 PSI) and mist nozzle. Instead of a garden hose, fire extinguisher tank at 100 PSI or a 20 gallon tank with a bladder containing pressurized solution at 50-100 PSI pressure is attached to the pressure washer as the source. The conventional spray tip is replaced with one or more spray tips from agricultural spraying for creating a 80° to 100° fan shape mist. In agriculture industry, these tips are according to how much water in GPM is sprayed at a 40 PSI. Spray tips that spray at 80° angle and at a rate of 0.1 (8001) to 0.3 (8003) to 2.0 (8020) gallon per minute for water at a pressure of 40 PSI are used. Commercial systems are available with large tanks being mounted onto the pressure washer and capable of operating several hoses simultaneously. The VMD for the pressure washer configuration was not measured but is expected to be very small for water. PNS is polymeric and has much higher surface tension. Creating a mist of foam containing PNS requires higher pressure than water.

Mono ester is R—O—P═O—(OH)₂. Diester is (R)₂—O—P═O—(OH). R comes from alcohol for alcohol based phosphate ester. R comes from ethoxylated alcohol (alcohol-ethoxylate) for ethoxylated alcohol based phosphate ester. R comes from specific ethoxylated phenol for ethoxylated phenol based phosphate ester. R comes from specific ethoxylated alkyl phenol for ethoxylated alkyl phenol based phosphate ester. Phenol (also called carbolic acid) is an aromatic organic compound with the molecular formula C6H5OH. Alkylphenols are a family of organic compounds obtained by the alkylation of phenols. The term is usually reserved for commercially important propylphenol, butylphenol, amylphenol, heptylphenol, octylphenol, nonylphenol, dodecylphenol and related “long chain alkylphenols”.

Alcohol ethoxylate is formed by the reaction of a fatty alcohol and ethylene oxide:

ROH+n C₂H₄O→R(OC₂H₄)ₙOH with n preferred to be 1-18. Fatty alcohols (or long-chain alcohols) are usually high-molecular-weight, straight-chain primary alcohols, but can also range from as few as 4-6 carbons to as many as 22-26, derived from natural fats and oils. The hydrophilic component of ethoxylated surfactants is currently based largely on ethylene oxide (EO) or poly (ethylene oxide) (POE).

Polyethylene glycol (PEG) is a polyether compound derived from petroleum with many applications, from industrial manufacturing to medicine. PEG is also known as polyethylene oxide (PEO) or polyoxyethylene (POE), depending on its molecular weight. The structure of PEG is commonly expressed as H—(O—CH2-CH2)n-OH.

An alkyl is a functional group of an organic chemical that contains only carbon and hydrogen atoms, which are arranged in a chain. They have general formula CnH2n+1. The definition in U.S. Pat. No. 6,696,399 of complex alkyl phosphate ester (CAPE) is adopted here with some modification. Complex alkyl refers to organic compounds chosen from the group comprising fatty alcohols, ethoxylated fatty alcohols, ethoxylated phenol, alkyl polyglycosides, ethoxylated alkylphenol, and alkyl aryl. The compounds alkyl polyglycosides are added to the examples of complex alkyl. Accordingly, a complex alkyl phosphate ester is chosen from the group comprising mono and dialkyl phosphate ester, alcohol phosphate ester, ethoxylated alcohol phosphate ester, alkyl polyglucoside phosphate ester, ethoxylated alkylphenol phosphate ester, ethoxylated phenol phosphate ester, alkyl polyglycoside ester, and alkyl aryl phosphate ester.

Correspondingly, complex alkyl sulfate ester (CASE) is described to include alcohol sulfate ester, ethoxylated alcohol sulfate ester, ethoxylated alkylphenol sulfate ester, and ethoxylated phenol based sulfate ester. Correspondingly, a similar definition for complex alkyl sulfonates. The complex alkyl includes compounds with and without ethoxylation.

Commercially, the complex alkyl phosphate ester surfactants are produced by the reaction of fatty alcohols, ethoxylated fatty alcohols, ethoxylated phenol or ethoxylated alkylphenol with the phosphating agents: orthophosphoric acid and phosphorus pentoxide. These commercial producers do not reveal the details of their production. Resulting surfactants are mixtures containing mainly monoalkyl and dialkyl phosphate esters as described in the company data sheets. The pH of these compounds are at least 2 indicating a significant number of diester bonds. This definition assumes there is one or two esters formed for each phosphate. Alkyl aryl acid phosphates are formed by the reaction of phosphoric pentoxide and an alcohol. The same is true for formation of alkyl aryl sulfonates.

We now describe several novel chemical precursor solutions central to the preferred compounds throughout this specification: 1) complex alkyl polyphosphate (CA-PPA) solution, 2) complex alkyl phosphate (CA-PA) solution, 3) complex alkyl phosphate ester polyphosphate (CAPE-PPA) solution, 4) complex alkyl sulfate solution (CA-SA) formed by the reaction of a complex alkyl compound and sulfuric acid (SA), 5) complex alkyl sulfonate solution (CA-SFA) formed by the reaction of a complex alkyl compound and sulfonic acid (SFA). These solutions are anhydrous chemical precursors that react with various cations to form compounds with surfactant properties, wetting agent, emulsifying, corrosion inhibition, and antistatic properties for a wide range of applications. These solutions readily react with ethyleneamine to provide a flame retardant property with continuous range of surfactant and FR compositions where the ratio of flame retardant EAPPA to surfactant can be varied over a wide range continuously by changing the ratio of complex alkyl compound to PA, PPA, SA, and SFA. The examples will show the behavior of these solutions for different complex alkyl compounds. The examples will be labeled CA-PA, CA-PPA, CA-SA, CA-SFA, CASE-PPA, or CAPE-PPA to readily distinguish the type of solution utilized. CAPE will refer to examples utilizing complex alkyl phosphate esters commercially available to make foam compositions and differs from CAPE-PPA. Sulfonic acid is not readily available and was not tried.

The complex alkyl polyphosphate (CA-PPA) solution in this specification is defined as the compound formed by the reaction of polyphosphoric acid and a complex alkyl compound at a wide range of concentrations. This solution is made without phosphorous pentoxide or orthophosphoric acid. It has been necessary to heat in a vessel to speed the reaction. The amount of heat necessary if any depends on the complex alkyl being reacted. The compound formed by dissolving polyphosphoric acid and a complex alkyl compound together in a heated vessel to form a clear solution with slight tint of color will be called complex alkyl polyphosphate (CA-PPA) solution. It is unknown how many actual ester bonds were formed. This compound reacted with an EA will be shown to have both flame retardant and foaming properties. The actual composition is difficult to define because PPA is complex. The complexity is in part due to the composition of polyphosphoric acid which inherently contains some orthophosphoric acid as well as pyro, tripoly, and longer chains depending on grade as already shown. We expect substantial steric hindrance in trying to esterfy long chain PPA and thus at least some of the phosphorous atoms will not have an ester bond. Long chain PPA also has fewer bonds available for forming esters. The orthophospric content inherent to PPA should form ester bonds. Commercial ethoxylated alcohol phosphate esters have a pH of about 2-2.5. Our complex alkyl polyphosphate solution has a lower pH (less than 1.95) indicating fewer ester bonds. It is possible that the primary reaction for some complex alkyl occurring is that the complex alkyl compound is solvating the PPA. So our definition encompasses the composition formed by dissolving complex alkyl compound in PPA with heat if necessary to form a transparent solution that usually has a brownish tint with unknown amount of formal ester bonds. It is likely that there are no diester or trimester bonds. The complex alkyl polyphosphate solution can react with many different cations and is a new compound. The different cations will be necessary for different applications. For soaps the cation will probably be alkali metal such as sodium or potassium. Ethyleneamines will be the cation where both foaming and flame retardance are necessary. More generally, the cation will be one or more compounds chosen from the group comprising ethyleneamine (EA), alkali metals, ammonia, and alkanolamines.

Complex alkyl phosphate solution was formed by the reaction of phosphoric acid (PA) and a complex alkyl. These are precursors that can be reacted with various cations to form compounds with surfactant properties, wetting agent, emulsifying, corrosion inhibition, and antistatic properties to a wide range of applications. This solution is different than complex alkyl phosphate esters as it is formed at all ratios of acid to complex alkyl and without phosphorous pentoxide. —The reactions of complex alkyl phosphate solution with EA results in compounds with surfactant and flame retardant properties. The ethyleneamine complex alky phosphate ester formed by reacting ethyleneamine with commercially available complex alkyl phosphate ester is different as will be shown. The foaming properties are not as good as that with complex alkyl phosphate (CA-PA) solution. The difference is attributed to the complex alkyl phosphate ester (CAPE) having about 50% diester bonds and reducing the ability to react with the ethyleneamine.

Complex alkyl phosphate ester PPA (CAPE-PPA) solution is formed by dissolving together PPA and a commercial complex alkyl phosphate ester. This solution is different than complex alkyl phosphate esters as it is formed at all ratios of acid to complex alkyl phosphate ester. This solution can be reacted with any cation. Reaction with an ethyleneamine results in a compound with both surfactant and flame retardant properties. The flame retardant properties of this compound are better than that of the ethyleneamine complex akyl phosphate ester.

A complex alkyl sulfate ester can be reacted with PPA to form a solution (CASE-PPA). This solution can then be reacted with EA to form yet more compositions with foaming and flame retardant properties. For example, dissolve or react lauryl ether sulfate (LES) with PPA to form a solution. A composition with flame retardance and surfactant properties is formed by reacting the LES-PPA solution with an EA. This sort of composition is not preferred as sulfates and sulfonates are more likely to have corrosion problems and environmental problems as compared to phosphates.

The surfactant compositions or compounds are formed by reaction of chemical precursors with EA to form compounds that have FR and surfactant properties. Similar compounds without self intumescence properties can be made by reacting CA-SA, CA-PPA, CA-PA, and CAPE-PPA with ammonia, alkanolamines, and alkali metals that are part of this invention. These compounds have lesser FR but may have superior surfactant property depending on the application.

These compounds with surfactant and flame retardant properties have been found to be applicable to the following applications: 1) flame retarding polymers which requires the compound to have little moisture sensitivity and melt into the polymer, 2) stopping a wildfire where the surfactant property promotes adhesion and spreading on class A fuel, and 3) foam for fuel fires where the foaming is essential to stop re-ignition or burnback resistance once the fuel fire is extinguished. Each application will require a different ratio of surfactant property to flame retardant property and the preferred composition may differ.

The gasoline used in all experiments is 87 octane gasoline that ordinarily contains 10% ethanol and is often called E10. MILSPEC gas is pure gas with no ethanol and is also called E0 gas. E10 gasoline burns hotter than MILSPEC gas and is more difficult to extinguish as burnback or re-ignition is more problematic.

PNS was made according to claim 1 in U.S. Pat. No. 10,501,602 with PPA 115%. The PNS-F in this specification was made by reacting CA-PPA solution with an ethyleneamine. The only EA used in this specification is DETA, but other ethyleneamines are applicable. PNS-F will also include any composition made by reacting an ethyleneamine with any complex alkyl sulfate solution, any complex alkyl phosphate solution, and any complex alkyl sulfonate solution.

A working hypothesis has been proposed in PCT-US20-05206 that DETAPPA mist reacts with the flames in fire to extinguish it by reacting with ions and free radicals and suppressing generation of heat. Now, our working hypothesis is that foam formulated with PNS-F in the form of a mist sprayed directly into a fire cools the fire and reacts with ions and radicals in the fire plasma. Foam droplets in the form of a mist have high surface area to support reaction with ions and radicals. However, the foam applied as a mist collects on the surface to form a continuous blanket or barrier on the fuel that extinguishes the fire and protects from re-ignition. Compositions will be formed with PNS-F that is effective applied as a mist or as a stream of foam. Examples show that PNS-F foam in the form of a mist is superior to PNS due to foam protection properties.

### FF Foam Discussion and Data:

Teflon is inert to burning. The fluorosurfactants in AFFF, such as fluorotelomers, perfluorooctanoic acid (PFOA), or perfluorooctanesulfonic acid (PFOS) are nearly inert to burning as these compounds consist almost entirely of Teflon like carbon fluorine bonds. AFFF foam is applied in a manner to form a barrier on top of the fuel. Here, this resistance to ignition will be called burn back resistance.

Fluorine free foams typically contain surfactants with organic constituents that burn in an intense fire. Here are some common examples of FF surfactants: soaps (free fatty acid salts), fatty acid sulfonates, sodium lauryl sulfate, sodium lauryl ether sulfate, ethoxylated compounds, such as ethoxylated propylene glycol, Lecithin, Polygluconates, basically a glorified name for short-chain starches. The most widely used surfactants are thought to be sodium lauryl ether sulfate (SLES), ammonium lauryl sulfate, ammonium laureth sulfate, sodium myristyl sulfate and sodium myreth sulfate. Phosphate surfactants of wide use are mono and dialkyl phosphate ester salts with the cations being sodium, potassium, lithium, and ammonium. Potassium lauryl phosphate is the most widely used.

Surfactants are compounds that lower the surface tension (or interfacial tension) between two liquids, between a gas and a liquid, or between a liquid and a solid. Surfactants may act as detergents, wetting agents, emulsifiers, foaming agents, and dispersants. Here, surfactants are compounds that lower the surface tension (or interfacial tension).

Organic solvents can be included to promote solubility of surfactants, to promote shelf life of the concentrate, and to stabilize the aqueous foam. Thickening agents can be used to increase viscosity and stability of the foam. Other agents and additives can be used as is known to those skilled in the art. Surfactants are included in the foaming compositions to facilitate foam formation upon aeration, to promote spreading of drainage from the foam composition as a vapor-sealing aqueous foam over a liquid chemical, and, where desired, to provide compatibility of the surfactant with sea water. Useful surfactants include water-soluble hydrocarbon surfactants and silicone surfactants, and may be non-ionic, anionic, cationic or amphoteric. When these surfactants are dissolved in water, negatively charged particles, i.e. anions, are created. Particularly useful surfactants include hydrocarbon surfactants which are anionic, amphoteric or cationic, e.g., anionic surfactants preferably having a carbon chain length containing from about 6 to about 12 or up to 20 carbon atoms. As used herein, an amphoteric surfactant is a molecule that contains both a positively charged atom and a negatively charged atom. Surfactant molecules may include polymeric components, and may also include a counter ion(s) such as sodium and ammonium, however the counter ion is not considered to be one of the positively or negatively charged atoms that qualifies the molecule as being an amphoteric surfactant. The amphoteric surfactant is a betaine surfactant, which means that the surfactant includes a betaine group. Amphoterism, in chemistry, reactivity of a substance with both acids and bases, acting as an acid in the presence of a base and as a base in the presence of an acid. Water is an example of an amphoteric substance. Silicone surfactants are a group of small-molecule and polymeric surfactants that find a wide variety of applications due to their unusual properties. They consist of a permethylated siloxane hydrophobic group (polydimethylsiloxane, pDMS) coupled to one or more polar groups. Silicone surfactants improve the quality of the foam by emulsifying incompatible formulation ingredients, lowering the surface tension, promoting nucleation of bubbles during mixing, stabilizing the rising foam by reducing stress concentrations in thinning cell-walls, and by counteracting the defoaming effect of any solids added to or formed in the process. Silicone surfactants should promote spreading of foam to form blanket over flammable liquids. Saccharide surfactants, such as the non-ionic alkyl polyglycosides, can also be useful to the composition. Organic solvents can be included in the foaming composition to promote solubility of a surfactant, to improve shelf life of a concentrated adaptation of the foaming composition, to stabilize the foam, and in some cases to provide freeze protection.

The FF surfactants are not considered flame retardants. Obviously, these surfactants have a high hydrocarbon content that will become fuel if the surfactant is subjected to an intense fire and the protective water evaporates.

Organic solvents useful in the foaming composition include but are not limited to glycols and glycol ethers including diethylene glycol n-butyl ether, dipropylene glycol n-propyl ether, hexylene glycol, ethylene glycol, dipropylene glycol monobutyl ether, dipropylene glycol monomethyl ether, dipropylene glycol monopropyl ether, propylene glycol, glycerol, polyethylene glycol (PEG) and sorbitol.

Thickening agents are well known in the chemical and polymer arts, and include, inter alia, polyacrylamides, cellulosic resins and functionalised cellulosic resins, polyacrylic acids, polyethylene oxides and the like. One class of thickener that can be preferred for use in the foaming composition and methods of the invention is the class of water-soluble, polyhydroxy polymers, especially polysaccharides. The class of polysaccharides includes a number of water-soluble, organic polymers that can increase the thickness, viscosity or stability of a foam composition. Preferred polysaccharide thickeners include polysaccharides having at least 100 saccharide units or a number average molecular weight of at least 18,000. Specific examples of such preferred polysaccharides include xanthan gum, scleroglucan, heteropolysaccharide-7, locust bean gum, partially-hydrolyzed starch, guar gum and derivatives thereof. Examples of useful polysaccharides are described, for example, in U.S. Pat. Nos. 4,060,489 and 4,149,599. These thickening agents generally exist in the form of water-soluble solids, e.g., powders. While they are soluble in water, in their powder form they can and typically do contain a small amount of adventitious or innate water, which is absorbed or otherwise associated with the polysaccharide.

Xanthan Gum is a microbial polysaccharide made from fermenting sugar with a bacteria called Xanthomonas campestris, which creates a gel that is dried and milled into a powder. The neutral-tasting gum acts as a powerful thickening, emulsifying, and stabilizing agent.

KELCO-VIS™ diutan gum offers a new and versatile approach to formulating new, high performance products with consistent quality and higher profitability. It is an exceptionally efficient stabilizer with strong pseudoplasticity and other unique properties that benefit a wide range of industrial applications such as liquid laundry detergent. Diutan gum is a polysaccharide used for applications that require very high suspending characteristics such as cement, gypsum, mortar, agricultural chemical applications, and oilfield drilling fluids, liquid detergent among others. Kelco-Care™ diutan gum is a water-soluble biopolymer produced by fermentation designed specifically for use in cosmetics and other personal-care applications. Kelco-Care™ diutan gum has exceptionally good thermal stability, is compatible with high levels of alcohol and polyols, and is readily biodegradable.

Another thickener especially compatible with EAPPA is fumed silica. It will not become fuel in an intense fire.

All the ingredients used to make fluorine free (FF) foams contain organic constituents that will be consumed in intense fires and the bubbles with these compounds will collapse. Very different than foam made from fluorinated surfactants will not contribute to fire and will not readily collapse its foam bubbles. The addition of a flame retardant such as EAPPA will lend resistance to these organic constituents being consumed in a fire. EAPPA does not evaporate and turns to char from flames or intense heat. Thus, EAPPA solutions added to FF foam will add resistance to evaporation of water by providing some protection to the organic constituents of FF foam.

Plunging is the direct application of flame retardant directly into the flames. Generally, for a flammable liquid fire, plunging not recommended as can splash the fire leading to spreading if using water, dry chemicals, carbon dioxide, or foam. Dry chemicals, carbon dioxide, and foam extinguishers are to be applied at the base of the flammable liquid fire. Foam should be sprayed gently starting at the edge of the flammable liquid fire to form a continuous blanket.

Low expansion foams are effective in controlling and extinguishing most flammable liquid (Class “B”) fires. LOW EXPANSION FOAMs are aerated to an expansion ratio of between 2 to 1 and 20 to 1. MEDIUM EXPANSION FOAM have an Expansion ratio between 20 to 1 and 100 to 1. High-expansion foams are those that expand in ratios of over 100:1. Most high expansion foams have expansion ratios of from 400:1 to 1000:1. Creation of foam requires an air aspirator or addition compressed air to a stream of aqueous liquid (such as water mixed with a surfactant) flowing very rapidly through an aspirator to form foam. Such devises are often called Venturi pumps or educators and are specially constructed to create foam. An eductor is a device that uses the Venturi principle to introduce foam concentrate into the water stream. Water coming in the inlet of the eductor is directed through a tapered section and out through a small orifice (the Venturi) into a larger chamber thus creating a low pressure area within the chamber. A metering valve is attached to an inlet to this chamber and when open allows the higher atmospheric pressure outside the chamber to push the foam concentrate into the chamber. The foam concentrate then mixes with the water coming out the Venturi and the mixture travels out the reverse tapered section in the discharge end of the eductor. Compressed air foam (CAF) consists of adding compressed air to a solution of water and foam concentrate and then expelled from a hose at high volume. Foam cannon is used in the car wash industry to create foam with a pressure washer and uses the Venturi principle.

Fluorine free (FF) foam concentrates are complex mixture of chemicals. The key ingredients are the solvents, thickening agents, water, and the surfactants. One of the few patents describing a FFF composition in detail is U.S. Pat. No. 7,569,155. One of their compositions contains 14 ingredients all of which must play some role: Water, Diethylene glycol monobutyl ether, Xanthan gum, Starch, Diethanolamine lauryl sulfate, Sodium decyl ethoxy sulfate, Cocamido propyl betaine, Cocamido propyl hydroxysultaine, Carbonised sugar mixture, Alkyl polyglycoside, Dextrose, Triethanolamine, Biocide, and Benzotriazole. Thus, those knowledgeable in FFF will undoubtedly add more ingredients such as these to our basic compositions to achieve particular commercially important properties.

The military MILSPEC test (MIL-F-24385F) is performed on a fire consisting 10 gallons of E0 gasoline in a 28 sq. ft. round tank and 15 gallons E0 gasoline in 50 sq. ft. round tank and also contains one inch of water. Ten gallons of gasoline added to a 28 sq. ft. tank will form a layer only 0.57 in thick. The fire performance is defined more specifically by U.S. MilSpec Mil-F-24385F, which is used to certify the performance of AFFFs for use in DOD firefighting applications and probably the most stringent compared to other standards of performance (e.g., International Civil Aviation Organization-ICAO, Underwriters Laboratories Inc.-UL) used in civilian applications. The test procedure also defines a foam Venturi nozzle. This nozzle will be referred to as a MILSPEC nozzle and is used in some of the tests presented here. One of the test performed under U.S. MilSpec is a fire extinction test that specifies that a 6-ft diameter gasoline pool fire (28 sq. ft.) be extinguished in less than 30 sec sprayed at a rate of 2 GPM. After spraying foam for 90 seconds, a burning one ft diameter pan with one gallon E0 gasoline is placed in the center of the tank. For burnback resistance, one then measures the time before one half of the tank has ignited by gasoline fumes escaping through the foam barrier. The flame from the burning one ft diameter pan with one gallon gas contributes to degrading the foam so that fumes feed the flames. The flames from the pan are small at first but then get higher and more intense as the fumes from beneath the foam feed the flames. The test is passed if the time to ½ burning tank is less than 360 seconds. This test is called backburn in that the foam layer needs to protect for 6 minutes from full re ignition for 28 sq ft test. The US congress has mandated that an FF foam be made to replace the current fluorinated foams that pass this MILSPEC test and is the target goal of this work.

A pressure washer can be used to create foam, as described in pct/us20/52061. Instead of a flat spray tip, a foam cannon is used. The foam cannon is a device that consists of a Venturi tube which is connected to a chamber containing a wire mesh tablet 0.61″ in diameter and 0.41 inches in height. So, the Venturi tube mixes air and foam solution which then goes through a wire mesh tablet to thoroughly mix the air and solution and create a very uniform foam much like shaving cream. Good choice to create foam with a power washer was the MTM Hydro PF22 Professional Foam Lance sold by Amazon.com. Professional car detailers wash cars with a pressure washer with a foam cannon. The foam cannon converts soapy water to a foam with which to wash cars. One of the most highly rated foam cannons is TORQ snow cannon EQP 321, which was used here and purchased from www.chemicalguys.com.

The MILSPEC nozzle and the foam cannon are similar in that both have the Venturi design. They differ in the dispersal cone. The foam cannon has a ⅜″ NPT feed line while the MILSPEC has a ½ inch NPT feed line. Both nozzles force the feed solution through a narrow channel into a much larger channel where air is sucked in and then through a smaller channel. For the MILSPEC nozzle, the air and solution are then mixed together in the smaller channel to form foam by a dispersal cone with a rounded tip that is 11/8″ long and ¼″ diameter. For the foam cannon, a wire mesh tablet 0.41 inch thickness is placed in the smaller channel whereby the foam and air is mixed and a foam looking like shaving cream exits. The foam from the MILSPEC nozzle is much coarser than the foam cannon foam. The MILSPEC nozzle could be easily modified to perform like the foam cannon by replacing the dispersal cone with a wire mesh tablet of at least 0.2″ in thickness, with 0.41″ more preferred.

It is very important that the foam land softly on the gasoline so not to substantially disturb the burning liquid surface. Foam near the surface of burning gasoline has high surface area which reacts with the ions and radicals streaming off the surface and thereby quenches the flame.

The commercial FF foams used here are National Foam Universal Green 3% by National Foam, West Chester, PA, and re-healing RF3 3×6 ATC (Solberg ATC) and Solberg RF3 supplied by Perimeter Solutions, Clayton, MO.

To create mist in most situations, it was preferred to use a flat tip nozzle that produces a fan shaped mist. The fan shaped mist is waved into the flames and moved from side to side to interact with the flames. It is preferred than the mist be directed downward towards the fire surface and maintain a distance above the surface so than no splashing of liquid occurs. The amount of mist needs to be adequate to douse the flames and not have a re ignition of flames. The volume of mist and area covered needs to be such that the fuel on one side of the fire has not reignited before the fan shaped mist has reached the other side. If the amount of mist is inadequate, then extra mist per unit time can be obtained with a boom containing several flat tip nozzles and possibly a higher pressure pump. Hundreds of different nozzles are available for agriculture and directly applicable here.

After many trials with flat fan nozzles, it was found that hollow cone nozzles perform better than flat fan as the mist lands more gently on the surface.

Mist can be formed at low pressure but only low volume of mist will be made. In the application PCT/US/20/52061, there are lengthy discussions about extinguishing fires with either a mist of PNS solution or a foam containing PNS. There was no disclosure of extinguishing a fire with foam converted into a mist. It was unexpected that a foam composition can be sprayed through a mist nozzle and form a mist without collapsing the foam. It had been assumed that the very small orifice of a misting nozzle would decompose the foam bubbles via compression. In fact, it will now be shown that mist of foam can be formed that has an expansion ratio of at least 5. First, a solution of 6% concentration Solberg ATC foam solution was sprayed through the Torq foam cannon. The foam was found to have an expansion ratio of approximately 8.5. The MILSPEC test requires an expansion ratio of at least 5. The foam cannon is modified by removing the plastic shield and welding a ¾ inch copper fitting to the tip of the foam cannon. This fitting was used to attach a boom with three to five spray tips from Teejet Co., (6798 Danboro Ct. NE, Rockford, MI 49341). A boom containing 5 nozzles was attached to the end of the Torq snow cannon in a rectangular pattern. The mist exiting the nozzles was measured to have an expansion ratio of 8.2 for nozzles 11015, 7.2 for nozzles 11008, and 6.2 for nozzles 8005 as compared to 8.5 without a boom. The nozzle did depress the Solberg ATC foam expansion by a small amount but are all acceptable to form foam that readily floats above gasoline. Thus, the foam bubbles formed in the foam cannon were able to survive exiting the nozzle even for a fine mist such as nozzle 8005.

The above Solberg ATC 3% foam solution was now applied to a 28 sq ft tank containing 5 gallons of gasoline. Application of the foam with the Torq foam cannon failed to extinguish the gasoline fire in 90 seconds. For the next test, a boom with 5 11015 nozzles were connected to the end of the foam cannon so as to form a mist of the foam. Application of the Solberg ATC foam in the form of a mist extinguished the 28 sq. ft. 5 gallon gasoline in fire in 55 seconds in one trial and 65 seconds in a second trial. The mist sprayed with a boom gave a much larger footprint to overcome the poor spreading coefficient of FF foams. The mist is applied at substantial pressure that attacks the surface and cools it. The mist being much lighter than gasoline quickly forms a protective barrier on the surface to stop re-ignition even though the bubbles break the surface of the fuel. Consequently, foam in the form of a mist is a simple method to improve performance of FF foam. AFFF foams sprayed as a mist would also be more effective if sprayed as a mist with a large footprint. AFFF is likely to dry out in a high temperature fire at which time the fluorinated compounds will decompose and form radicals that react with the flames and help quench the fire. This a key property that FFF foams do not have. We aim to add FR behavior to FFF for this reason.

In the MILSPEC test, the foam needs to spread rapidly over the gasoline as the foam is applied. Thus, AFFF foams composed primarily of Teflon like carbon fluorine bonds will spread especially rather easily in a fire driven by the energy of the heat. Another over looked property of AFFF foams is that they spread easily in a fire because they have less reaction with neighboring chain. FF foams composed of very sticky FF surfactant bonds are harder to energize to spread out and thus have a poor spreading coefficient as compared to AFFF foams. Applying as a mist over a large area helps overcome the inherent problem of spreading over the fire especially if using nozzles with a spray angle of 110° as will now be done.

Now, more evidence is provided for the advantages of forming a foam of the foam solution with PNS and then converting to a mist. Foam in this specification is formed by adding air to a foam solution (water and foam concentrate) using an educator or aeration nozzle to suck air into the solution at a pressure of at least 100 PSI. In the previous examples, a foam cannon (a type of aeration nozzle) was used to create foam from a foam solution comprising 3% to 6% foam concentrate and water. The advantage of this method is that the mist created stops all flaming and the foam accumulates on the surface of the water to form a coating on top of the fuel and provide burn back protection.

An important property of PNS solutions is that PNS reacts vigorously with sulfate and phosphate surfactants. This direct reaction of the flame retardant with a surfactant was not disclosed in PCT/US20/52061. Mixing SLES 27% concentration with PNS solution results in a viscous solution that resembles a gel. This reaction is much milder if at all when SLES is mixed directly with a foam concentrate such as Solberg ATC.

The SLES surfactant used in all examples is SLES 27% concentration purchased from the web site www.chemicalstore.com.

Example 1 DETAPPA added to SLES foam: A foam solution was prepared by mixing together in a blender 400 g 67% concentration of DETAPPA-FS with 8 g xanthan. Then, 400 g SLES (27% concentration) was added and hand mixed as the solution becomes very viscous due to interaction of SLES with DETAPPA-FS. This solution is then added to 4000 g water and mixed for about five minutes at which time 140 g ethylene glycol butyl ether was added, all done in a large food mixer and there is dramatic reduction in viscosity. After about one hour, that solution is added to 9000 g water and stirred with a spatula. The solution is then pumped into a 20 gallon standard water tank from with a bladder. An air compressor was then used to pump air into the bladder and mix with the solution with the final pressure being 75 PSI. The tank was than attached to 4000 PSI Simpson pressure washer to serve as the liquid feed for the pressure washer. The Torq foam cannon modified with a boom containing 4 nozzles (size 11020) was connected to the 50 ft. ⅜ inch hose from the pressure washer. The foam exiting the foam cannon weighed about 120 g/800 ml (6.6 expansion). The foam exiting the boom with 4 spray tips is about 165 g/800 ml (4.9 expansion), indicating the extra step of forming a mist decreases the expansion ratio. In a 28 sq. ft. tank was placed 5 gallons of water followed by addition of 5 gallons E10 gasoline. The gasoline was ignited and after 10 seconds the foam in the form of a mist is applied. It was unexpected that the fire extinguished in 30 seconds and a foam layer formed on the surface. Spraying of the mist was continued for 60 seconds and the foam layer became thicker. After 6 minutes, a torch was applied to the surface of the foam layer. There was no ignition of the gasoline under the foam layer indicating substantial burn back properties. The results were superior to that obtained with applying a stream of foam from the foam cannon where the extinction time exceeds 60 seconds. The mist seems to be reacting with the gas plasma and cooling the flame as the tester felt the emitted heat to substantially be reduced when the mist was applied.

Example 2: The identical procedure was followed again except 8 g of xanthan was replaced with 12 g of KELCO-VIS diutan from CPKelco, a Huber company. The burn timed was 33 seconds. Diutan is a replacement for xanthan.

Next a mist formed from a 45% solution of DETAPPA-FS was applied to a 5 gallon gasoline fire in the 28 sq. ft. tank as in the foam/mist example. The PNS mist failed to extinguish the fire within 60 seconds at which time the tank went dry. The mist was more effective at knocking down the flames, but poor at cooling the sides of the tank that reignited the fire as quickly as it was extinguished. This example shows the importance of foam in extinguishing fuel tank fires. The surfactant is crucial for foaming.

The commercial FF foams contain surfactants that are not flame retardants. The flame retardant such as PNS can be added to the FF foam with resultant decrease in foaming. These surfactants can be replaced by a new surfactant PNS-F that is also a flame retardant which will now be described. It is also possible to make this surfactant along with the flame retardant PNS simultaneously in order to obtain a compound that is both a flame retardant and a foaming agent surfactant. PNS-F can be added without a decrease in expansion ratio.

Phosphate esters such as lauryl phosphate are water insoluble. One of the shortcomings of EAPPA is that they are water soluble and thus limit their usefulness in forming flame retarded polymer compositions for wire and cable applications. Thus it would be useful to form ester bonds with lauryl alcohol for some of the bonds in polyphosphoric acid and then react with an ethyleneamine.

The complex alkyl sulfate esters are produced by the reaction of fatty alcohols, ethoxylated alcohols or ethoxylated phenol with sulfuric acid. Lauryl ether sulfate (LES) is prepared by ethoxylation of dodecyl alcohol and reacting with sulfuric acid.

Soap applications often use glycol ether to act as coupling agent by compatibilizing the hydrophobic oils and soil with water to hold the dirt in suspension. The compatibilizing role is probably the reason for ethylene glycol in FF foams. The glycol ether used as a solvent (co-solvent) includes any of the reaction products of ethylene oxide or propylene oxide and some version of alcohol including methanol, ethanol, propanol, butanol, hexanol. These may include any of the following ethylene oxide based materials, for example: ethylene glycol monomethyl ether, ethylene glycol monoethyl ether, ethylene glycol monopropyl ether, ethylene glycol monobutyl ether, ethylene glycol monohexyl ether, ethylene glycol phenyl ether, diethylene glycol methyl ether, diethylene glycol monoethyl ether, diethylene glycol monopropyl ether, diethylene glycol monobutyl ether, diethylene glycol monohexyl ether, triethylene glycol monomethyl ether, triethylene glycol monoethyl ether; and they may include any of the following propylene oxide based materials, also for example: propylene glycol monomethyl ether, propylene glycol monopropyl ether, propylene glycol monobutyl ether, propylene glycol t-butyl ether, propylene glycol phenyl ether, dipropylene glycol monomethyl ether, dipropylene glycol monopropyl ether, dipropylene glycol monobutyl ether, dipropylene glycol dimethyl ether, tripropylene glycol methyl ether, tripropylene glycol n-butyl ether, propylene glycol methyl ether acetate, and dipropylene glycol methyl ether acetate.

The product glycol ether EB (ETHYLENE GLYCOL MONOBUTYL ETHER) was obtained from Chemistrystore.com. Silwet L-77 was obtained from Dewolf chemical distributor (dewolfchem.com). Silwet L-77 is a nonionic organosilicone surfactant co-polymer that has enhanced wetting and spreading characteristics when used in aqueous sprays. It can also be used as a wetting agent since it reduces the surface tension of aqueous solutions. Silwet® is a registered trademark of Momentive.

Ethoxylated alcohol phosphate esters are available commercially. Of the many that are available, three have been chosen here as typical: Crodafos T6A from www.Crodaindustrialchemicals.com and Stepfac 8180 and 8182 from Stepan Corporation, Northfield, IL, 60093. Stepfac® 8180 is described as a polyethylene glycol monotridecyl ether phosphate (or phosphate ester of an alkyl polyethoxyethanol) with 3 moles EO, 42% monoester, and 53% diester and is dispersible in water. Stepfac® 8182 has 12 moles EO, 45% monoester, and 37% diester and is soluble in water. Stepfac® 8181 has 6 moles EO and is dispersible in water. The pH range is from 2-3. Crodafos® T6A is a phosphate ester on tridecyl alcohol with 6 moles EO. These products may also contain approximately 1% phosphoric acid. The water solubility is better because of presence of EO than that with lauryl phosphate. These phosphate esters have the properties of emulsifier, detergent, hydrotrope, corrosion inhibiter, wetting agent, solubilizer, and dispersant. We will show examples whereby reacting such phosphate esters with an ethyleneamine such as DETA results in compounds that have the property of flame retardants as well as foaming. Lauryl phosphate is water insoluble but is hydroscopic in hot humid air, possibly result of impurities. LP has an acidic pH and acids tend to attract water.

Stepan Co. provides a series of ethoxylated fatty alcohols Polystep® TD series, Makon UD series, Makon DA series, or Makon®TD series. The company ACME HARDESTY, Blue Bell, PA has product called lauryl alcohol ethoxylate 2 mol EO and 9 mole EO which will be used here. Stepan Co. furnishes Makon® TD-6 has 6 ethylene oxide. Makon UD series are C11 branched alcohol ethoxylates. Makon Da-4 (4EO) is dispersable in water and Makon DA 6 (6EO) and 9 (9EO) are soluble in water. Makon UD 5 (5EO) is dispersable in water and soluble at concentration less than 10%. Makon UD 6 (6EO) and 8 (8EO) is soluble in water at concentration greater than 10%. Makon TD 3 (3EO) is insoluble in water, TD6 (6EO) is dispersable in water, TD 8 (8EO), 9,12,18 (18EO) are soluble in water. Thus, as the amount of EO increases, the solubility in water increases. Solubility depends on the particular fatty alcohol being ethoxylated as well. The TD series is tridecal alcohol, the UD series is C11 branched alcohol ethoxylate, the DA series is C10 isodecal alcohol ethoxylate.

Kelco-Care™ diutan gum is a water-soluble biopolymer produced by fermentation designed specifically for use in cosmetics and other personal-care applications. Kelco-Care™ diutan gum has exceptionally good thermal stability, is compatible with high levels of alcohol and polyols, and is readily biodegradable. Kelco-Care™ diutan gum is a water-soluble biopolymer produced by fermentation designed specifically for use in cosmetics and other personal-care applications. Kelco-Care™ diutan gum has exceptionally good thermal stability, is compatible with high levels of alcohol and polyols, and is readily biodegradable.

Dodecyl phosphate ester (CA-PE) was obtained from BOC Sciences at web site www.bocsci.com. It is insoluble in water. The terms lauryl and dodecyl are used interchangeably. The procedure to form the salts of dodecyl phosphate ester was demonstrated with the formation of dodecyl phosphate ester and potassium dodecyl phosphate ester according to U.S. Pat. No. 6,262,130.

To form DETA lauryl phosphate ester, lauryl phosphate ester was melted and then DETA added slowly until a pH of 5 to 8 has been reached. A foam sample of DETALP was formed by dissolving 160 g LP in 3600 g hot water. That was followed by addition of 4 g xanthan and 34 gram of glycol ether EB. The solution has a pH of 2. Addition of 52 g of DETA gave a pH of 6.7. This composition gives an expansion ratio of 5.3 with the pressure washer but only 2.7 expansion ratio with Amerex foam fire extinguisher. Much better results would be obtained had the foam solution been sprayed as a fine mist.

Diethylenetriamine phosphate is a good flame retardant, as subjected to a flame this compound intumesces. Ammonia phosphate does not intumesce in a flame. It is found that DETA lauryl phosphate (DETALP) will also intumesce.

The DETALP containing solution was turned into foam in a blender and 75 g placed in a high wall pan. Second foam sample was similarly formed from a 6% solution of Solberg ATC. Both were placed in a propane grill pre heated to 600° F. The heat causes the Solberg ATC foam to expand and pretty much fill the pan at 2 minutes. The Solberg ATC starts to collapse at 3 minutes. The DETALP expands to fill the pan at 2 minutes but continues to expand even further at 3 minutes and has spilled over the walls of the pan. This is interpreted to mean that the DETALP foam expands without the bubbles bursting rapidly substantially better than Solberg ATC. Such behavior was expected as DETA is a cross linker of exceptional performance with epoxies. DETALP containing foam is found to have substantially better heat resistance.

The amount of solution remaining in the pan for Solberg ATC was 23% as compared to 43% for DETALP, even though some of the DETALP foam escaped over the side.

### Synthesis of Aqueous Diethylenetriamine Lauryl Phosphate (DETALP) Solution:

Charge 52 g dodecyl (lauryl) phosphate (LP), 0.5 g xanthan, 3 g glycol ether EB, and 2100 g hot water (60° C.) to a blender and mix so that the LP is suspended in the water. Next, the solution from the blender was charged to a mixer and 9 g DETA was added. Polyphosphoric acid grade 115% was added to lower the solution pH to approximately 6.

Some of the DETALP solution was added to a metal container to form a layer about ½ inch deep. A torch was applied and a layer is formed on the surface as the torch dehydrates. Eventually, an intumescent char was formed as the liquid evaporated showing that this compound has flame retardant properties.

About 4 gallons of the DETALP solution was added to a 20 gallon water tank with a bladder. The solution in the tank was pressurized to 90 PSI. The tank was attached to 4000 PSI Simpson pressure washer. The hose was outfitted with a Torq™ foam cannon. The foam cannon has attached a linear array of four foam nozzles (Teejet TFVS 10) about 4 inches apart. This setup was found to form foam with an expansion ratio of 7-8 thus demonstrating the surfactant properties of DETALP. Later, it will be shown to have an expansion ratio less than 5 with a MILSPEC nozzle.

To test foam extinguishing properties, the foam formulation was applied to a 28 sq. ft. fire containing 5 gallons of standard gasoline that contains ethanol at 10% level (E10 gasoline). The fire was extinguished in 30-40 seconds if the nozzles were Teejet 8003 that sprays a fine mist of the foam. The fine mist spray nozzles caused the expansion ratio to decrease to about 3-4. Clearly, the fine mist of foam reacts with the flame plasma. The spray was continued for a total of 90 seconds. A foam layer formed on the surface that has a long lifetime of at least 60 minutes. A torch applied to the surface of the foam on top of the E10 gasoline did not ignite the gasoline. Such behavior demonstrates burnback protection in that the gasoline does not re-ignite, a critical requirement of the MILSPEC test. However, the DETALP has a tendency to drop out of solution if allowed to stand for a month which requires better candidates be made for foam applications. Ethoxylation of the alcohol will be found to enable solutions that have a long lifetime without dropping out. Such compounds in the non aqueous form would be better for addition to polymer compositions where low water solubility is preferential.

The same procedure could be used to synthesis EA lauryl sulfate solution. Other ratios of acid to base could be done as well as other concentrations. It will be also be necessary to form the solution obtained by reacting together PPA and LP with heat and then adding EA.

### Procedure for Synthesis of EA Lauryl Phosphate (CAPE)-PPA:

Add lauryl phosphate and PPA at a given ratio depending on the application to a reactor that is heated to a temperature that easily melts the lauryl phosphate and stirs easily so that the product can be extracted. Start addition of an ethyleneamine such as DETA and start mixing. The reactor temperature may need to be raised so that the EA lauryl phosphate product is melted and stirs easily. Upon completion, collect the product, EA lauryl phosphate ester-PPA. Other ratios of acid to base could be done.

The term melt temperature definition has to be expanded for the compounds of this invention. Some phosphate and polyphosphate may not have a melt temperature. The compositions soften with temperature and at some point stir easily. They tend to be thixotropic. As these compounds may be made in a kettle, then the temperature of the kettle has to such that the compounds can be extracted easily which requires a temperature at which the product flows. The final temperature has to be a temperature at which the composition flows so that it is extractable. It has been important to not stop the mixing at a given temperature until the product has been extracted as very difficult to get the mixing restarted. Thus, this temperature will be referred to as a flow temperature. For compounds made in aqueous phase or a missed aqueous-organic solvent, the temperature has to such that dissolves the parent compound which usually is the complex alkyl phosphate solution or sulfate. This temperature will be referred to as the solution temperature.

### Synthesis of a Mix of Ethyleneamine Lauryl Phosphate and Ethyleneamine Polyphosphoric Acid (CAPE-PPA):

Another approach is demonstrated with formation of aqueous solution of EALP doped with EAPPA. The specific example will use DETA. Charge 53.3 g dodecyl (lauryl) phosphate (LP), 0.5 g xanthan, 3 g glycol ether EB, and 2100 g hot water (60° C. to 80° C.) to a blender and mix so that the LP is dissolved/suspended in the water. Next, the solution from the blender was charged to a mixer and 15 g DETA was added to obtain a pH of about 8.5 to 9. The extra 3 grams of DETA was then neutralized by addition of approximately 6.7 g polyphosphoric acid grade 115% to lower the pH to about 6-7. Thus, this method comprises making a solution of EA complex alkyl phosphate solution with excess EA in hot water and then adding polyphosphoric acid to neutralize the excess EA. Alternately, the method comprises adding polyphosphoric acid to hot water, then addition of complex alkyl phosphate, and then addition of the EA to obtain a pH of about 6-7. The same procedure holds for the other complex alkyl sulfates.

In a similar fashion, DETALS (DETA lauryl sulfate) and DETALES (DETA lauryl ether sulfate) could be made with the anhydrous approach. The aqueous approach would utilize lauryl sulfate (LS) and EA or Lauryl ether sulfate (LES) and EA.

### EXAMPLE EA—(CAPE-PPA) MIXTURE OF EAPPA and DETALP

Forty eight LP and 48 g of PPA 115% were melted together in stainless steel pressure cooker to form a clear solution, which we designate as DETAPPA/LP. The ester bonding is pre incorporated in the LP. Then 34 g DETA was added so very little escaped. This left in hot humid air for two weeks did not get sticky. A sample of LP left in air at same time and conditions became very sticky although the LP did not dissolve. A chunk of DETAPPA left in air at same time actually liquefied, completely dissolved. A second DETAPPA/LP sample was formed from 25 g LP and 54 g PPA and 34 DETA that is flexible. Left in hot humid air as two previous samples, the sample is slightly sticky but does not liquefy. Thus, these experiments give a clear path to form samples for polymers with greatly reduced moisture sensitivity as required for polymers.

### EXAMPLE CA-PPA FORMATION OF A MIXTURE OF EAPPA AND DETA ETHOXYLATED TRIDECYL ALCOHOL POLYPHOSPHATE

Twenty five g Makon TD3 and 48 g of PPA 115% were mixed together at room temperature in a stainless steel pressure cooker to form a clear solution of ethoxylated tridecyl alcohol polyphosphate solution (complex alkyl polyphosphate solution). There was no need to heat to 400° F. to get the reaction to proceed. It is necessary to heat the reaction vessel to a temperature such as 400° F. to extract the product by pouring it out. The pot gets fairly hot indicating a reaction. The solubility and reaction was a little surprising as Makon TD3 is not soluble in water. Then 34 g DETA was added so very little escaped. A flexible solid formed. This left in hot humid air for two weeks gets a little sticky but at a rate that is much less than DETAPPA. This sort of composition which resists moisture compared to EAPPA has utility in flame retarding polymers.

Phosphorous pentoxide will not be used. To form the ethoxylated alcohol polyphosphate solutions (CA-PPA), first preheat a reactor such as a 10 L Henschel mixer to a temperature of at least 100° C. but less than 220° C. Add about 1600 g polyphosphoric acid 115% and stir. Decide on what percentage of the final composition should be reacted with a complex alkyl compound such as Makon TD3. Then, add Makon TD3 at a concentration that yields the correct ratio in this CA-PPA. Other ethoxylated alcohols could be added depending on the application. Continue mixing until the reaction has completed and the solution has formed. Then add DETA so that a pH between 3 and 9 is achieved. A pH of 9 means that extra DETA has been added. This procedure could be done with other ethoxylated alcohols as well or with other fatty alcohols. This procedure will be defined as a method for making ethyleneamine ethoxylated complex akyl polyphosphates with EAPPA in any desired ratio depending on the application. It is possible that the ethoxylated alcohol is only reacting with the phosphoric acid content of the polyphosphoric acid to form esters. Long chain PPA seems to have very few bonds which could form esters.

Example 4 (CA-PPA viscosity): The reaction of PPA and complex alkyl is further explored in next examples. For this example, Makon DA-9 (C10 alcohol primarily) from Stepan company will be combined with PPA 115% at a temperature of 400° F. At a ratio of 200 g Makon DA 9 to 75 g PPA, the viscosity is considerably higher than that of PPA or Makon DA9 by itself. At a ratio of 175 g Makon DA9 to 100 g PPA, the viscosity has increased over previous example. At a ratio of 150 g Makon DA9 to 100 g PPA, the viscosity increased further. At a ratio of 125 g Makon DA9 to 150 g PPA, the viscosity is still higher and the color which was increasing now is a reddish tint. The viscous solutions are all transparent even as viscosity increased. These results indicate a strong bond between the two components. There is no indication of separation in aqueous solutions. The behavior resembles that of hydrophilic fumed silica dissolved in PPA. Mixing at room temperature was not successful in getting these two ingredients to form a transparent solution with a brownish/reddish tint as happens at 400° F. readily. The molecular weight of Makon DA 9 is about 550 and the molecular weight of PPA is in range of 85 to 90 depending on grade. These examples contained more moles of PPA than that of Makon DA 9. The weight of all samples is identical. As the amount of PPA to Makon DA9 increased, the amount of EA to neutralize to PH neutral increased as expected.

Solvate refers to the process in which there is some chemical association between the molecules of a solute and those of the solvent. It is possible that the ethoxylated complex alkyl fatty alcohol is solvating the PPA especially the long chain portion and not formally an ester. We will however define the solvated acid as a solution for the proposes of defining compositions of interest. There does not seem to be any reverse of the solvation process, the alcohol stays associated with acid even after reaction with the ethyleneamine. Esters could be forming with the orthophosphoric acid content of PPA 115%. This effect would be much larger for PPA 105% which has nearly 50% orthophosphoric content.

The few samples are foam samples generated in a very similar procedure.

Example 1 CA-PPA: DETA ethoxylated tridecyl alcohol polyphosphate formation: The first step was to mix 150 g PPA 115% and 360 g Makon TD3. A clear solution forms with substantial heat released, a reaction occurred. The clear solution is heated at 60-80° C. for five minutes to insure complete reaction. Add 192 g of this solution to 2100 g hot water (about 80° C.) in a blender. Eleven g Ethylene Glycol EB was added and the solution was mixed. Next, the contents of the blender were added to a standard dough mixer. The last step was to add 60 g of DETA. Four batches were made and the pH was 8.2 indicating excess DETA. DETA is a cross linker and extra DETA was added for that reason as we are looking to make a foam blanket to smother a fire. Some of the solution was placed in a blender and mixed. A foam was made with expansion ration of 5. The solution was also added to a tank pressurized to 50 PSI and attached to the 4000 PSI Simpson pressure washer. The pressure washer hose was attached to a Torq foam cannon. The foam cannon had 10 Teejet fine mist 8003 attached to it in rectangular wand configuration. The foam thus generated in this manner had an expansion ration of 6.4 which is excellent considering the fine mist generated.

Example 2 CA-PPA: Foam concentrate formation: For practical application, it will be necessary to form a foam concentrate. Thirty g of the above composition (150 g PPA 115% and 360 g Makon TD3) was mixed with 9.4 g of DETA in a sealed pressure cooker. The pot was heated to 80° C. to make sure the reaction was complete. The pot was unsealed and the ingredients thoroughly mixed. A solid substance was formed that was flexible. Thirty g of this solid DETA ethoxylated fatty alcohol polyphosphate was mixed with 350 g water and 2 g of glycol ether EB in a blender. A foam formed with an expansion ratio of 4.5 to 5 on several trials. Thus, this pure 100% product could be mixed with water when needed at a fire. It would also be possible to dissolve it in water with a few per cent water, for example, one to one ratio by weight. Thus, the pure product or a concentrated aqueous form could then be practically shipped to fire situations to be used by fire departments.

Example 3 CA-PPA: 45 g of PPA 115% was added to 135 g of ACME HARDESTY lauryl alcohol ethoxylate 2 mol EO. The two did not react after sustained mixing. However heating in a closed pressure cooker at about 400 F for 5 minutes did get the reaction initiated. One more treatment got the full reaction to form, a purple syrupy solution which is transparent at thin coating. The product cooled to a gel. This product will be referred to as lauryl ether polyphosphate solution with two moles EO. This product 27.3 g was mixed with 1.5 g glycol ether and 300 g water in a blender to form a foam. DETA 8.6 g was added to the blender but the amount of foam remained about the same. The pH was 9.4 and the expansion was 4.85. The next sample contained 27.3 g product, 1.5 g glycol ether, 300 g water, and 6.0 DETA. The addition of DETA did not change the amount of foam. The expansion ratio was 5.0 and the pH was 7.0. The foam was heated with a torch and it took 3 minutes to convert 45 g of foam to char. Thus, this new compound had foaming agent properties and flame retardance. Thus, the product is defined by the process of reacting an ethoxylated fatty alcohol with PPA at a temperature less than 450° F. in a closed contained and then neutralizing with DETA. To make a foam concentrate, glycol ether and water would be added before addition of DETA. It seems that ethoxylated fatty alcohol reacts more easily with PPA as the alcohol chain gets longer.

Example 4 DETA ethoxylated fatty alcohol phosphate ester (CAPE): For this example, 192 g Stepfac 8180 (contains a lot of diesters) was added to a blender containing hot water at a temperature of 60-80° C. Eleven g ethylene glycol EB was also added and the solution was blended. Next, the contents of the blender were added to a standard dough mixer. The last step was to add 30 g of DETA. Four batches were made and the pH was 8.0 indicating excess DETA. The solution was also added to a tank pressurized to 50 PSI and attached to the 4000 PSI Simpson pressure washer. The pressure washer hose was attached to a Torq foam cannon. The foam cannon had 10 Teejet fine mist 8003 nozzles attached to it in rectangular wand configuration. The foam thus generated in this manner had an expansion ration of 6.2 which is excellent considering the fine mist generated.

Example 5 DETALP: The third sample was made by adding 120 g LP to 2100 g hot water (60-80 C) in a blender along with 11 g glycol ether EB. The solution was added to a dough mixer. While stirring, 30 g DETA was added. Four batches were made and the pH was 7.9 indicating excess DETA. The solution was also added to a tank pressurized to 50 PSI and attached to the 4000 PSI Simpson pressure washer. The pressure washer hose was attached to a Torq foam cannon. The foam cannon had 10 Teejet fine mist 8003 nozzles attached to it in rectangular wand configuration. The foam thus generated in this manner had an expansion ration of 7.7 which is excellent considering the fine mist generated. It is to be noted that only 30 g of DETA was used whereas earlier example of this set of used 60 g DETA, further suggesting the prevalence of monoesters.

Example 6 DETA ethoxylated alcohol sulfate: The fourth sample was made by mixing 150 g sulfuric acid 96% concentration and 360 g Makon TD3. A clear solution forms with substantial heat released, a reaction occurred at room temperature. The clear solution is heated at 60-80° C. for five minutes to insure complete reaction and the color changed to purple but still very transparent. Add 192 g of this solution to 2100 g hot water (about 80° C.) in a blender. Eleven g Ethylene Glycol EB was added and the solution was mixed. Next, the contents of the blender were added to a standard dough mixer. The last step was to add 60 g of DETA and the pH was 9.1. The next batch was made with 55 g DETA and the pH was 8.7 indicating excess DETA. DETA is a cross linker and extra DETA was added for that reason as we are looking to make a foam blanket to smother a fire. Some of the solution was placed in a blender and mixed. A foam was made with expansion ration of 3.3. The solution was also added to a tank pressurized to 50 PSI and attached to the 4000 PSI Simpson pressure washer. The pressure washer hose was attached to a Torq foam cannon. The foam cannon had 10 Teejet fine mist 8003 attached to it in rectangular wand configuration. The foam thus generated in this manner had an expansion ration of 5.3 which is excellent considering the fine mist generated by fine mist nozzles. This foam subjected to a propane torch did not seem to from an intumescent char as did the composition.

Similarly, ethoxylated complex alkyl fatty alcohol can be reacted with sulfonic acid to form the ester. Then, an ethyleneamine is reacted with an ethoxylated complex alkyl fatty alcohol sulfonic acid ester. These sulfonic acids are not readily available and examples will not be provided.

### EXAMPLE 7 CA-PPA: A METHOD TO PREPARE PNS-F AT 50% CONCENTRATION FOR WILDFIRE CONTROL

In a glass blender, 7.5 g of the complex alkyl Makon DA-9 and 160 g of PPA 115% were added and mixed at 400 F to form a slightly tinted clear solution (CA-PPA). Then, 265 g of water was added and mixed. Then A copper tube was inserted through a small hole drilled into the blender lid. While mixing at lowest speed, 91 g of DETA was added into the ⅛ inch inner diameter tube 2 g at a time. The DETA addition required about 7 minutes. The solution pH was 5.7. The temperature of the solution was 155° F., a result of exothermic reaction. There was not any noticeable leakage of vapors from the blender. The pressure buildup did not lift the lid off either, although there was some pressure from the heated air in the bender

A ¼ inch wooden dowel 12 inch long was coated very thinly with the solution just prepared. The dowel was suspended vertically over a propane torch propped up so the flame rose vertically into the dowel. The tip of the torch was 2 inches from the tip of the dowel. The torch was ignited. The dowel burns a little near the bottom with about 4 inches getting charred. The flame was small and very little heat was released. There was no formation of embers, indicating the absence of infrared radiation. Once the torch was stopped, the charred part of the dowel cooled in a few seconds. By comparison, an uncoated dowel burned in identical fashion was consumed very rapidly leaving behind an ember that was about 12 inches long and which quickly broke off. The ember continued radiating infrared radiation and was hot to the touch. It is apparent that an analogy can be made to the difference between incandescent bulbs and LED bulbs. The visible light is similar. However, an incandescent bulb is too hot to touch whereas one can easily touch an LED bulb. Thus, an uncoated dowel burns with radiant heat that can ignite neighboring fuel. A coated dowel burns without long wavelength radiant heat and stops being hot once the heat is removed. Thus, fuel coated with PNS-F or foam doped PNS is robbed of the ability to catch neighboring fuel on fire, a key to stopping a wildfire. Addition of foaming function to PNS improves film formation so that the solution applied to a surface is less likely to drip off. The PNS-F foam solution is more likely to form a film that does not drip off.

Another method to prepare PNS at 50% concentration. Method consists of using the primary ingredients PPA 115% and DETA without external heat. In a glass blender, 265 g of water and 160 g of PPA 115% were added and mixed. A copped tube was inserted through a small hole drilled into the blender lid. While mixing at lowest speed, 91 g of DETA was added into the ⅛ inch inner diameter tube 2 g at a time. The DETA addition required about 7 minutes. The temperature of the solution went up to 155° F.

It was unexpected that complex alkyl phosphate esters dissolve in polyphosphoric acid especially if heat of 50° C. to 100° C. is applied. This generalization is based on several esters thus far dissolving in PPA 115% to form CAPE-PPA solutions. The CAPE-PPA is then reacted with EA to form the mixed compositions of EAPPA and ethyleneamine complex alkyl phosphate esters.

Another family of compounds is formed by reacting a complex alkyl phosphate solution or complex alkyl polyphosphate solution with both ethyleneamine and an alkali metal hydroxide or reacting a complex alkyl sulfate solution with both ethyleneamine and an alkali metal hydroxide.

The above formulations for foam were done at concentrations of 5% to 10% relative to weight of water. The formulations for making foam will be made at high concentrations. Such concentrations will then be diluted at the point of use on actual fires by the addition of water.

### EXAMPLE 8 SYNTHESIS OF AQUEOUS DIETHYLENETRIAMINE ETHOXY (6) ISOTRIDECANOL PHOSPHATE ESTER

Charge 20 g ethoxy (6) isotridecanol phosphate (Crodafos T6A), 7 g glycol ether EB, and 350 g hot water (60° C.) to a blender and mix. Next, while continuing to mix, 4 g DETA was added. The solution immediately responded by foaming. It was found that 1200 ml of this foam weighed about 236 g, an expansion of 5.1. The pH was about 9.0. Ethoxy (6) isotridecanol phosphate ester with 6 moles EO was obtained from the Croda Company as Crodafos T6A.

The experiment was repeated but with 3 g DETA. It was found that 800 g of foam from the blender weighed 182G. The pH was about 8.3.

### EXAMPLE 9 OF DETA ETHOXYLATED TRIDECYL PHOSPHATE ESTER (CAPE)

The ingredients 120 g Stepfac® 8180, 7 g ethylene glycol EB, and 1100 g hot water were mixed together in a blender. This mixture was then added to a mixer with an additional 1000 g hot water. Then 18 g DETA was added quickly with mixing and continued for five minutes. The final solution pH was 8.3 and will be referred to as DETA ethoxylated tridecyl phosphate ester. The procedure was repeated 7 more times at which time it was added to a pressure tank. The tank was pressurized to 58 PSI and attached to a pressure washer Simpson 4000 PSI. The solution was sprayed through a Torq foam cannon to which was attached a boon of 10 Teejet® 8003 fine mist spray nozzles. The expansion ratio was found to be 8.5 much higher than previous example with the thickener xanthan. The system was successful in extinguishing a 28 sq. ft. tank fire containing 5 gallons regular gasoline. The foam left on top of the tank and covering the unburned gasoline exhibited burn-back resistance when subjected to a propane torch after 10 minutes.

### EXAMPLE 10 FORMATION OF A MIXED PRODUCT OF DETAPPA WITH DETA ETHOXYLATED ALCOHOL PHOSPHATE SOLUTION OR ETHOXYLATED ALCOHOL POLYPHOSPHATE SOLUTION

It is also possible to form a mixed composition which is partially ethyleneamine polyphosphate and partially ethyleneamine complex alkyl phosphate. A method to form ethyleneamine polyphosphate (EAPPA) comprises the step of reacting an ethyleneamine (EA) and polyphosphoric acid (PPA) under substantially anhydrous conditions at a EA/PPA reaction ratio and at a reaction temperature so that the reaction of EA and PPA goes substantially to completion to form a solution (CA-PPA). This method will be followed except that both polyphosphoric acid and a complex alkyl phosphate solution will be charged to a reaction vessel a given ratio. The temperature is normally about 400° F. so that the product is easily extracted. After the solution of CA-PPA is formed, EA is added and the reaction allowed to completion. The reaction product can then have the properties of a surfactant and a flame retardant. Fumed silica can also be added to the acids before addition of EA to form a mixed doped product.

A flame retardant mixed composition which is partially ethyleneamine polyphosphate and partially ethyleneamine complex alkyl phosphate solution is a flame retardant applicable to all thermoplastic and thermoset polymers provided the melt temperature of the polymer does not exceed the thermal stability of the mixed composition. The preferred polymers are olefins such as ethylene vinyl acetate (EVA), polyethylene, and polypropylene. An olefin is defined as a macromolecular compound of the general formula that forms during polymerization or copolymerization of unsaturated olefin hydrocarbons (R, R′═H, CH3, C2H5, and so on). A typical composition for W&C applications consists of 0% to 1% fumed silica, 15% to 65% of a flame retardant mixed composition which additionally contains 1-3% by weight fumed silica within the mixed composition and one or more EVA polymers. An expert skilled in such compositions would add minor ingredients for UV stability, color, thermal stability, etc.

### EXAMPLE 11 ANHYDROUS EA-LAURYL PHOSPHATE ESTER

Such anhydrous compounds are specifically designed for use in flame retarding polymers. Sixty grams of LP was added to a 1.5 L pressure cooker. It was heated to about 150° C. At that point, about 11.g DETA was added through the vent port for the pressure cooker pressure release valve with a plastic pipette. The pot was cooled to about 120° C. and then opened. The product was thoroughly mixed with a spatula. The DETALP anhydrous did not dissolve at room temperature. A piece left in hot humid air did not get sticky in contrast to PNS which gets sticky readily in air containing moisture. It takes about 12 hours to get a little sticky. A piece of PNS in hot humid air actually liquefies to about a 70% concentration. DETALP does not liquefy in hot humid air which makes it a good candidate for addition to polymers.

### EXAMPLE 12 ANHYDROUS DETA (LP-PPA)

For polymer applications, a flame retardant with less moisture sensitivity is needed. With this intent, samples of DETA reacted with a mixture of polyphosphoric acid and a complex alkyl phosphate solution will be shown. For example (CAPE-PPA), 48 g of PPA 115% and 48 gram of lauryl phosphate were mixed together in a 1.5 L pressure cooker and heated to about 150° C. to form a CAPE-PPA solution. The temperature is needed to be such that the LP or any other complex alkyl phosphate melts and can be extracted. Then, a pipette was used to add 34 g of DETA through the vent relief valve. Once there was very little emission of smoke from the vent hole, the composition was cooled to about 80° C. and then opened. A spatula was used to thoroughly mix the composition. Some product was placed in water (10% concentration by weight) mixed for a long time. The product DETA (PPA-LP) did not dissolve well but a pH of 5.3 was obtained. A 15 g piece of PNS and a similar size piece of the product were placed in a hit humid environment for 12 hours. PNS became quite sticky whereas the product did not get sticky at all, thus overcoming a limitation of PNS: moisture absorption. The sample subjected to a torch intumesces very nicely but char peels off with a cracking sound probably from exploding lauryl content.

The same procedure was repeated with 54 g PPA 115% (0.6 m), 25 g LP (0.09 m), and 34 g (0.33 m) DETA, The same procedure was repeated with 54 g PPA 115% (0.6 m), 25 g LP (0.09 m), 4 g glycol ether EB, and 34 g (0.33 m) DETA with m designating moles and at a temperature that melts the LP and final product. The pH was found to be 5.0 and 4.9 respectively after letting a piece sit in stirred water for about 3 hours for both samples. The moisture absorption for both was very low as compared to PNS. When a piece of either DETA (PPA-LP) was subjected to a torch, the intumescent car seemed nearly the same as PNS subjected to a torch. The glycol ether does not make an obvious differentiation. There was no cracking sound either as the amount of lauryl was reduced by one half from previous example of DETA (LP-PPA).

Example 13 CAPE: Sixty grams of PAE 147 from Lakeland Laboratory, Manchester, England was added to a 1.5 L pressure cooker. PAE 147 has the tetradecanol alcohol with 7 moles EO and the ratio of monoester to diester is 12:1. Then, 3.8 g glycol ether EB was added to the PAE 147 and mixed over heat. Then the pressure cooker was sealed and 9 g DETA was added through the pressure cooker vent pipe for the pressure regulator. The temperature was allowed to rise to 110° C. at which point the lid was removed. A spatula was used to thoroughly mix the ingredients. A gel like consistency was obtained that flowed slowly. The gel solution seemed clear. Some gel was dissolved in water and a pH of 5.9 was obtained. Such a composition could be used to from a concentrate that could then be diluted as used on a fire.

Example 14 CAPE: A second experiment was done using 60 g PAE 147, 10.5 g DETA, 26 g water, and 3.8 g glycol ether EB and same procedure. The gel like composition flowed much better and had a pH of 7.1. Such a composition could be used to from a concentrate that could then be diluted as used on a fire.

The same procedure was used again: 60 g PAE 147, 3.8 g glycol ether EB, 9.5 g DETA. The composition was transparent and dissolved in water to obtain a pH of 6.9. This composition could also form a concentrate and contains less EO.

The foam made with DETA ethoxylated tridecyl phosphate solution (CAPE) can be made more effective if an EAPPA solution is added. EAPPA doped DETA ethoxylated tridecyl phosphate solution (CAPE-PPA) is more effective in reacting with flames but does not cause the foam to collapse. The above compounds could be made with other ethoxylated alcohols that form foam.

In general it is expected that flame retarded polymer compositions formed with the EA-(complex alkyl phosphate-PPA solution) composition will have reduced water absorption due to the addition of hydrophobic ester bond as compared to flame retarded polymer compositions containing very hydroscopic PNS. For flame retarded polymer compositions, it will be preferred that fumed silica has been added to CA-PPA solution before adding DETA.

Fire extinguisher compositions for wildfires and structural fires may utilize aqueous PNS solutions up to about 50% concentration. Such aqueous compositions could be appropriate for spills of flammable liquid fires.

The military MILSPEC test (MIL-F-24385F) limits the foam concentration to 6%. Ordinarily, the FFF or AFFF foam is delivered as a concentrate that is diluted with water to a concentration range of 3% to 6% by weight at the fire site and applied. Examples with ethoxylated fatty alcohols above have the capability to form concentrates. This concentrate could then be diluted with water at application to a fire as foam is being made and applied.

It is possible to form EA complex alkyl sulfate esters or EA complex alkyl sulfonate esters in a similar manner.

The DETALP foam composition and DETA ethoxylated tridecyl alcohol polyphosphate (n=2 and n=3) foam compositions were tested with a MILSPEC nozzle for expansion. Unfortunately, the foam expansion was only in the range of 2 to 4, much smaller than the values presented for the power washer and foam cannon in the examples thus far. The primary reason is that the MILSPEC operates at only 100 PSI, the velocity of the foam solution is much slower than in a pressure washer at 3000 psi to 4000 psi. The MILSPEC nozzle could be converted to a foam cannon by replacing the dispersal cone with wire mesh pill ¾ inch in diameter. Then, this nozzle could be capable of using an array of hollow cone nozzles to form a mist with large footprint.

The next set of examples contain examples that have expansion greater than 5 as measured with an Amerex 250 foam fire extinguisher operated at 100 PSI and with a MILSPEC nozzle at 100 PSI.

The compositions presented thus far have a role to play for flame retarding polymers, wildfire extinction, and certain foams. PNS introduced into foam compositions takes a toll on foam expansion ratio for a MILSPEC nozzle. Thus, a new set of compositions are now introduced and referred to as PNS-F. PNS-F compositions contain both flame retardant properties and foaming agent properties.

Another test method will be added now along with new device attachment to standard Venturi type foam nozzles such as the MILSPEC. The 28 sq ft is too big to differentiate compositions. Differentiation also requires multiple repeat tests which is impractical with a 28 sq ft. test. The department of defense has put forward another test called Challenge 2021. The test can be observed on youtube.com entitled SERDP & ESTCP AFFF Challenge 2021 (https://www.challenge.gov/challenge/2021-serdp-afff-challenge/). Foam is created in a blender in this test. The foam is applied by pouring foam created with the blender down a ramp (3.5 in wide with 2 inch sides) into a one sq. ft. pan containing one inch of water and 500 ml gasoline that has been ignited and burning for 10 seconds. The amount of foam to extinguish the fire is measured and recorded. The ramp is one cinder block high (16 inches) on one side and is positioned 16 inches from the pan. This test will be used to compare various foam compositions. We will not report the time to extinction as the fire goes out quickly or not all. In all FFF samples tested, the fire is either extinguished quickly or it will burn until smothered with a cover made of drywall. To make the test more realistic, a commercial Amerex 250 foam fire extinguisher or a MILSPEC nozzle will be used to create foam instead of a blender. The foam is sprayed into a bucket and then poured onto the ramp and the amount of foam used is weighed. It has been found that similar expansion ratio is found with the Amerex 250 fire extinguisher and with the MILSPEC nozzle.

It is also important to explore the optimal fatty acid (C8 to C14) and not focus only on ethoxylated tridecyl alcohol (primarily C13), as has been done thus far. The degree of ethoxylation is also important which is between 2 and 12. We have used a process that forms primarily monoesters.

The Challenge test has also enabled us to optimize the ethoxylation. For tridecyl alcohol, the optimum moles of ethylene oxide (EO) is n=6 to 12 with n=9 being most preferred. Compositions with n=0, 1, 2 or 3 have poor expansion with the Amerex 250 fire extinguisher. The poor expansion resulted in these compositions doing poorly in the challenge test.

Steric hindrance could be significantly different for EDA, DETA, TETA, and TEPA, and piperazine. Ionic strength is likely to be EA dependent. Properties such as emulsion, wetting, and surface tension could affect spreading coefficient. For 1 sq ft gasoline fires, the amount of foam needed to extinguish the gasoline fire is very sensitive to the degree of ethoxylation. It is expected other factors will be important as the search is expanded beyond DETA to other ethyleneamines.

It will be important to visit the formation of SLES with EA's substituted for sodium. Currently, SLES is only made with the ethoxylation n=1 and 2. This SLES composition was not optimized to pass MILSPEC. It is envisioned to make EA ethoxylated fatty alcohol sulfates with ethoxylation of n up to 12. Thus the general compound is ethyleneamine ethoxylated fatty alcohol sulfate, with n=1 to 12 and C8 to C14 fatty alcohol.

Control: As a control, the first test was National Foam Universal Green 3%. A 2100 g solution at 3% concentration was formed of the National Foam product and added to the Amerex fire extinguisher and pressurized to 100 psi. The foam was sprayed into a bucket and then igniting the pan fire. After 10 seconds, the foam was poured down the ramp. It was surprising that 330 g of foam was required to extinguish the pan fire containing 500 ml gasoline and 1 inch water. The expansion ratio was only 3.5 which was also surprisingly low. Foam created with a pressure washer and Torq foam cannon had given much higher values of expansion of at least 5 for National Foam concentrate. Thus far, FFF compositions including the ones of this invention form higher expansion ratios with the pressure washer/foam cannon setup than with the commercial Amerex 250 foam fire extinguisher. The difference in expansion can be greatly reduced by proper choice of ethoxylation n and fatty alcohol.

New FF foam compositions using a surfactant formed by reacting an EA with ethoxylated tridecal alcohol polyphosphate solution (n=9-12) (CA-PPA) have high expansion ratios of 6 to 9 with a Amerex 250 foam fire extinguisher and are now presented.

Example 15 Formation ethoxylated tridecyl alcohol polyphosphate solution (CA-PPA): To a one quart stainless steel pressure cooker was added 51 g of PPA 115% along with 225 g of an ethoxylated tridecal alcohol. Samples with ethoxylated alcohol with n=3, 6, 9, 12, 18 were generated. Other ratios of acid to alcohol (51 g, 265 g and 65 g, 225 g) were tried but best results are 51 g and 225 g. The cooker was sealed and heated to 400° F. for about 5 minutes in a closed propane grill. The pot was opened and then mixed for about 5 minutes while still heating. After about 3-5 minutes, the PPA and alcohol were mixed together with a spatula to form a clear solution of ethoxylated tridecal alcohol polyphosphate solution, anhydrous. The clear solution is stable and remains so regardless of temperature. The reaction was more difficult and takes longer for n=1 or n=2 ethoxylation. There was no way to know exactly what formed except by its properties and reproducibility. Thus, a ethoxylated tridecal alcohol polyphosphate solution presumed to be mostly mono ester polyphosphate was formed by this process. Because of the large size of the ester molecules, steric hindrance could affect the composition.

Example 16 Formation of diethylenetriamine ethoxylated tridecyl alcohol polyphosphate (DLEPP): In all samples, a total of 2000 g of water was collected. This sample size is large enough to perform four trials of the Challenge 2021 test at different amounts of foam. In the first step, 66.7 g of ethoxylated tridecal alcohol polyphosphate solution was mixed with 15 g of glycol ether EB and then added to 1500 g of water in a mixer. DETA was added so that the pH was between 7.2 to 7.5 which is about 11 g to 12 g of DETA depending on the degree n of ethoxylation. From 1 to 5 g of xanthan was dissolved in 350 g water in a blender to form an opaque solution. The xanthan solution was mixed in to form the FFF. The solution was added to the Amerex 250 foam fire extinguisher and pressured to 100 psi. Of the four tests, the challenge was passed at 184 g and 208 g but failed at 160 g and 170 g. The 170 g came close to going out but did not due to burning at the edges. The test was repeated and these results are representative. Testing at n=3 behaved poorly as there were solubility issues as a sol or cloudy solution formed. Testing at n=9 was nearly as good as n=12. Testing at n=6 was acceptable as the challenge was passed at 200-210 g.

The preferred compositions for use with a Amerex 250 fire extinguished are more restricted than with the pressure washer. Pressure washer with foam cannon makes good foam under a much wider composition range than the traditional fire extinguisher. More flame retardant compositions are then enabled with the pressure washer setup.

Alkyl PolyGlycosoide is obtained from renewable raw materials by reacting a mixture of one or more alcohols with Glucose or Glucose Polymers. These surfactants are usually glucose derivatives, and fatty alcohols. The raw materials are typically starch and fat, and the final products are typically complex mixtures of compounds with different sugars comprising the hydrophilic end and alkyl groups of variable length comprising the hydrophobic end. When derived from glucose, they are known as alkyl polyglycososides. Alkyl glycosides are produced by combining a sugar such as glucose with a fatty alcohol in the presence of acid catalysts at elevated temperatures: lauryl glycosoide (glucose+lauryl (C12-C14), alcohol), Decyl Glycosoide (60% C8-C10, 40% C12-C14), Coco Glycosoide (40% C8-C10, 60% C12-C14). Decyl Glycosoide containing compositions foam up quickly, but the foam also disappears fast compare to others. The low viscosity presents excellent fluid fluidity. Decyl glycosoide was first used in soaps and body cleansers because of its great foaming power. Foaming surfactants are detergents and differ from emulsifying surfactants by their HLB (hydrophilic lipophilic balance) value. Foaming surfactants generally have an HLB of greater than 18 and better still greater than 20. The liquid versions are diluted with water providing an active matter content from 50% to 70%. Non bleached grades are indicated by the index “DK” and are brownish liquids, whereas the bleached grades are colorless to yellowish liquids. Contrary to fatty alcohol ethoxylates their foaming property is much stronger. In addition they have excellent solubilizing and film forming properties. Alkyl polyglycosoide can be used in fire equipment as foaming agent.

Glucopon® grades (alkyl polyglycosoide) by BASF are nonionic surfactants and considered an alternative to sulfate containing surfactants. Alkyl polyglycosides are made from saturated native alcohol and glucose, wherein said alkyl group has from about 8 to about 14 carbon atoms. Glucopon 225 dk by BASF has alcohol C8-C10, moderate foaming behavior, and alkaline stability up to pH 13.

### EXAMPLE 16 DLEPP-GLUCOPON 225 DK FOAM (CA-PPA)

Glucopon 225 DK can be added directly to any FFF composition. Glucopon 225 DK can be added directly to any CA-PPA, CA-PA, or CAPE-PPA composition. For example, LEPP12 was formed by reacting 51 g PPA 15% and 225 g Makon DT12 to form a clear solution. Next, 66 g of LEPP12 was mixed with 15 g glycol ether EB and then 50 of water was added. Ten g of glucopon 225 DK was added. Then, to this solution was added 1700 g water and 13 g DETA, a pH of 7.4 being obtained. The last step was to add 0.75 g xanthan dissolved in 250 g water to form DLEPP. The DLEPP was added to Amerex 250 fire extinguisher and pressurized to 100 psi. The challenge test was passed with 240 g, 218 g, and 187 g with foam generated with Amerex 250 foam fire extinguisher.

### EXAMPLE 17 PPA-GLUCOPON ESTER (CA-PPA)

React 51 g PPA and 225 g glucopon 225 at 140 F to from a tan solution due to color of Glucopon 225 DK. Weigh 2000 g of water. Mix 65 g of tan solution with 15 grams glycol ether EB. Mix in approximately 100 g of water followed by an additional 1000 g of water. Then add DETA until a pH between 7 and 8.5 is reached, which is about 11 g. The CA-PPA solution was added to the Amerex 250 fire extinguisher which made foam with expansion greater than 5 which should perform well in the challenge 2021 test.

This example (CA-PPA) shows that FF foam compositions can be formed with very good expansion ratio by using complex alkyl polyphosphate solution without the necessity of glycol ether solvent. First, 100 g PPA and 175 g Makon DA9 were reacted together. The actual composition could differ depending the reaction was carried at a different temperature or different length of time. Someone familiar with such compounds would resolve such dependencies. Then, 131 g of this solution was mixed with 5 g of xanthan dissolved in 250 g water and the pH was 1.75. To this solution was added 40 g DETA and the pH was 7. The foam made with the MILSPEC nozzle had expansion ratio 7.6. This foam put out the fire in the Challenge test at 200 g to 235 g. We made this example again but also added 30 g Glucopon 225 DK. The expansion ratio increased to 8.1. The results for the challenge test were similar. Thus, good expansion ratio obtained without the necessity of a glycol ether. Such FF foam is more environmentally friendly because the glycol ether is not used.

Example 18 (CA-PPA) 100 g PPA was reacted with 175 g Makon DA9 at 400° F. to form clear solution. Then, 80 g of DETA was added slowly but some escaped. This composition doe not dissolve in water easily and requires substantial mixing. Twenty two g of this compound was dissolved in hot water and the pH was only 5.8. DETA was added to obtain a pH of 7. This solution was added to 5 g xanthan that had been dissolved in 11 g glycol ether and 1000 g water. Separately, 50 g Solberg RF3 concentrate was dissolved in 1000 g water. The solutions were combined. The solution was added to pressure tank at 100 PSI. The MILSPEC nozzle gave an expansion ratio of 4.6 for the foam. Addition of 216 g of foam to 1 sq. ft. gasoline pan fire gave extinction. This is not preferred because of the difficulty of dissolving DETA ethoxylated fatty alcohol PPA in water. For foam and wildfire applications, it is much easier and preferred to dissolve the solution in small amount of water and then add DETA or some other ethyleneamine.

The 1 sq ft tests have been done outdoors thus far and wind has been found to cause the results to vary. For the following tests, three 30 inch by 5 ft panels were constructed of metal sheets with 2×4 inch wood supports. The panels are held together by door hinges. These panels are positioned to nearly enclose the 1×1 ft pan by almost a triangle. The space between the panels is about 12 inches so that one can reach in and pour the foam generated with the MILSPEC nozzle down the ramp. The metal panels hold the heat and flames in and keep the mind and air currents out so that the results are acceptably reproducible. It is not necessary to perform a control burn with Solberg RF3 every day.

The next examples represent the best performing CA-PPA samples along with the control Solberg RF3, as based on results of challenge test. All were done with same procedure:
1) All the composition were formed with the same procedure for the 1 sq ft challenge test. Compositions were formed by the following reactions. First, 100 g PPA was reacted 175 g Makon 6 at a temperature of 400° F. to form a clear CA-PPA solution with a brownish tent. Next, 50 g of this solution was dissolved in 200 g water. This solution was then reacted with 15.5 g DETA. Then 12 g of Silwet L-77 was added and mixed. Separately, 2.2 g xanthan was mixed with 11 g glycol ether EB and then added to 2000 g water. The two solutions were mixed together. The solutions were added to a tank which was pressurized to 100 PSI and attached to a MILSPEC nozzle. The challenge test was preformed several times. The foam had an expansion ratio of 8.4. The 500 ml of EO gasoline in a 1 sq ft test was successfully extinguished with 150 g and157 g of foam. This sample was also tested at 28 sq ft at Naval Research Laboratory the official test site for the MILSPEC test. The extinguishment time was 85 seconds. The burnback time was 3 minutes. It was observed that the foam layer was deteriorating during the course of the test. The burnback time was also cut short due to flames occurring through the foam blanket. It will be shown later that the addition of more xanthan is required to increase the burnback time.
2). The composition and results will be given for the next examples using the same procedure for the 1 sq ft test with 500 ml EO gas and the MILSPEC nozzle to form foam. 100 g PPA was mixed with 175 g Makon DA6 at 400° F. to form a solution. 50 g of this solution was mixed with 2200 g water, 5 g xanthan, 11 g glycol ether EB, 12 g Silwet L-77, 14.5 g DETA to give a solution with pH 7.8. The expansion ratio was 8.0. The 1 sq ft test was passed at 186 g and almost passed at 160 g.
3) The next example 100 g PPA was mixed with 175 g Makon UD8 at 400° F. 50 g of this solution was mixed with 2200 g water, 5 g xanthan, 11 g glycol ether EB, 12 g Silwet L-77, 16 g DETA to give a solution with pH 6.8. The expansion ratio was 6.3. The 1 sq ft test was passed at 182 g 174 g 176 g.
4) The next example 75 g PPA was mixed with 200 g Makon DA6 at 400° F. 50 g of this solution was mixed with 2200 g water, 5 g xanthan, 11 g glycol ether EB, 12 g Silwet L-77, 13.3 g DETA to give a solution with pH 6.9. The expansion ratio was 9.0. The 1 sq ft test was passed at 170 g 172 g and 207 g.
5) The next example 75 g PPA was mixed with 200 g Makon DA6 at 400° F. 50 g of this solution was mixed with 2200 g water, 5 g xanthan, 11 g glycol ether EB, 12 g Glucopon 225 DK, 13.2 g DETA to give a solution with pH 7.1. The expansion ratio was 10.4. The 1 sq ft test was passed at 151 g, 159 g, but failed at 132 g.
6) The next example 100 g PPA was mixed with 175 g Makon DA6 at 400° F. 50 g of this solution was mixed with 2200 g water, 5 g xanthan, 11 g glycol ether EB, 10 g Glucopon 225 DK, 14.2 g DETA to give a solution with pH 7. The expansion ratio was 8.8. The 1 sq ft test was passed at 166 g, 171 g, but failed at 144 g.
7) The next example mixed 100 g PPA was mixed with 175 g Makon DA9 at 400° F. 50 g of this solution was mixed with 2200 g water, 5 g xanthan, 11 g glycol ether EB, 10 g Glucopon 225 DK, 14.9 g DETA to give a solution with pH 7.1. The expansion ratio was 9.3. The 1 sq ft test was passed at 167 g, 188 g, but failed at 161 g. Using 85 for MW of PPA and 422 (158 mw alcohol+6 mw EO) for Makon DA 6, Fifty g of the CA-PPA solution amounts to 0.21 m PPA and 0.08 m Makon DA 6. With mw of DETA being 103, 0.15 m of deta used give a pH 7.1. Thus, these ratios of molecular weights was unexpected and unexplained. It was unexpected that the ratio of PPA to EA would be quite different than that used to form EAPPA in PCT/19/034077 and PCT/20/52061. The ratio of CA to PPA is unexpected. The molecular weight ratios of examples throughout this specification are unexpected.
8) The next example 100 g PPA was mixed with 175 g Makon DA9 at 400° F. 50 g of this solution was mixed with 2200 g water, 10 g Crodafos T6A, 5 g xanthan, 5.1 Silwet L-77, 11 g glycol ether EB, 15 g DETA to give a solution with pH 6.8. The expansion ratio was 7.7. The 1 sq ft test was passed at 169 g, 180 g, and 246 g. This example shows that the addition of Crodafos T6A phosphate ester is effective as an additive in the 1 sq ft fire.
9) For a control, 68 g of Solberg RF3 was mixed with 2200 g water. The 1 sq ft test was performed as the other tests. The expansion ratio was 6.1. The 1 sq ft test passed at 210 g and 201 g but failed at 193 g.
10) The next example 100 g PPA was mixed with 175 g Makon DA9 at 400° F. to form a solution. 22 g of this solution was mixed with 2200 g water, 38 g Solberg RF3, 4 g xanthan, 11 g glycol ether EB, 7.4 g DETA to give a solution with pH 7.4 and expansion ratio 7.1. The 1 sq ft test passed at 233 but failed at 197 g. Solberg RF3 has better expansion ratio by adding DETA complex alkyl polyphosphate solution, but 1 sq ft performance about the same.
11) The next example 22 g of Crodafos T6A was mixed with 2200 g water, 38 g Solberg RF3, 4 g xanthan, 11 g glycol ether EB, 3.8 g DETA to give a solution with pH 7.4 and expansion ratio 2.44. It seems that the phosphate ester Crodafos T6A causes unacceptable foam expansion ratio.
12) The next example 87 g PPA was mixed with 188 g Makon UD5 at 400° F. to form a solution with a pH of 1.5 when mixed with water. 38.2 g of this solution was mixed with 7.6 g Glucopon 225 DK, 2200 g water, 1.7 g xanthan, 8.4 g glycol ether EB, 11 g DETA to give a solution with pH 7.1 and expansion ratio 11.1. The 1 sq ft test passed at 177 g, 175 g, and 135 g. This example is the best performance at 1 sq ft and the concentration was only 3%. It seems that reducing the amount of thickener improved performance.

This sample was tested at 28 sq ft by the MILSPEC test at NRL. The extinguishment time was 83 seconds and the burnback time was 2 minutes 45 seconds. The foam blanket suffers burn through as the test progresses.
13) The next example 87 g PPA was mixed with 188 g Makon TD3 at 400° F. to form a solution and a 10% aqueous solution had a pH of 1.6. 38.2 g of this solution was mixed with 7.6 g Glucopon 225 DK, 2200 g water, 1.7 g xanthan, 8.4 g glycol ether EB, 10 g DETA to give a solution with pH 7.1 and expansion ratio 6.6. The 1 sq ft test passed at 233 g and failed at 184 g. This example shows poor performance at 1 sq ft and the concentration was 3%. Of particular concern is that the foam solution was cloudy indicating that all the ingredients are not completely dissolved. Particulate would be highly problematic if a concentrate was allowed to sit for months. Thus, Makon TD 3 with 3 EO does not have as good solubility such as Makon UD5 and will not be considered a candidate for FFF. Makon TD-3 could be a candidate for polymer and wildfire applications.

First eight compositions along with 12) are considered best candidates to pass the 28 sq ft test. The number of tests that can be done at 28 sq ft is limited, so it is unlikely that the Makon DA9 composition will be tested. —These compositions relative to total weight had a total concentration of 3.9% or 3%. The variables still needing to be tested are pH, glycol ether, other ethoxylated fatty alcohols, silicone surfactant, and alkyl polyglycoside. That however will wait until 28 sq ft test burns are done with 10 gallons E0 gasoline.

A single stream of foam with a MILSPEC like nozzle is preferred to extinguish fuel tank fires. More preferred is the use of pressure washer that applies a large footprint fine mist of foam into the flames, which the mist foam particles collect on the surface and form a barrier on the surface. The mist consists of droplets with a volume median diameter (VMD) less than 1500 micron, or less than 600 micron preferred, or less than 400 micron more preferred, or less than 200 micron even more preferred, or less than 75 microns most preferred. Unfortunately, testing agencies such as US Department of Defense (DOD) and UL® only have tests utilizing a single stream of foam which is the procedure that is applicable with these FFF.

Another test is now introduced to test for burn through the foam blanket and backburn or re ignition. The test will be referenced as the tub test. AFFF foam is known to have far superior burn through and burnback properties than FFF. A standard metal tub from the hardware store was obtained that has a 3.14 sq ft (24 inch diameter) base with 13 inch sides that taper up. The bottom is 2 ft in diameter and the top is 2 ft 6 inches in diameter. Two gallons water and 1100 g (1375 ml) E10 gasoline is always added to the tub before the test begins. For reference the MILSPEC burnback test contains 3780 ml of gasoline for the 28 sq ft fire. The FFF solution is then made into foam by adding to a pressure tank, pressurizing to 100 PSI, and spraying as foam with a MILSPEC nozzle. The foam expansion ratio is measured. 600 g of foam is collected in a bucket and poured into the tub containing gas over water. To the tub, a heavy metal pan 11 in by 7 in and 2 in deep containing 450 g (1375 ml) E10 gasoline was placed in the center of the tub. This is all done within 30 seconds so as not to allow the foam to degrade. The pan is ignited. The heat generated by the burning gasoline causes the foam to degrade and vapors to seep through the gasoline from the gasoline below the foam and on top of the water. Initially, the flame height is only about 12-18″ high as only gas in the pan is feeding the fire. One sees the flame height grow to 5 ft high being fed by vapors that percolate through the foam blanket. By about 2 minutes, the foam blanket begins to burn and the test is stopped by placing a cover over the tub. One can observe the foam blanket thinning as the fire progresses and then failure of the blanket to control emission of vapors.

Numerous FFF foam solutions (CA-PPA and CA-SA) have been made and tested with the tub test. The same procedure was followed for making each FFF composition. A FFF composition is formed by mixing together sulfuric acid 96% or PPA 115% and an ethoxylated alcohols Makon DA 4 or Makon UD5. The SA is done at room temperature while the PPA is done at 400° F. in a propane grill. Then 2200 g of water is mixed with 50 g of the sulfuric acid-ethoxylated alcohol solution or 50 g of PPA-ethoxylated alcohol solution. DETA is added to obtain a pH of 7 to 8. Separately, 5 g xanthan or diutan is mixed with 1100 g water. The two solutions are mixed together to form FFF without glycol ether. The solution is placed in a pressure tank and pressurized to 100 PSI. Foam is created with a MILSPEC nozzle and 600 g collected in a bucket. The foam is poured onto the tub described previously and already containing 2 gallons water and 1100 g of E10 gasoline. The metal pan with 450 g of E10 gasoline is placed in the center and ignited. The time until about ½ of the tub is covered in flames is recorded.

The first example is a control made with 600 g of 3% solution of Solberg RF3 spread over 2 gallons of water in the tub. The test was conducted by placing the pan containing 450 g gasoline and it took 115 seconds before the fire had to be extinguished. The foam expansion ratio was 8.47.

The next example was prepared from reacting 87 g PPA and 188 g Makon UD5. FFF foam was prepared from 50 g of this solution, 2200 g water, and DETA to give a pH of 7. The fire had to be extinguished in 23 seconds and the expansion ratio was 10.03. The results are terrible because of the absence of xanthan or diutan. The next example contained the same ingredients but 5 g of xanthan had been added. The fire is extinguished at 143 seconds and the expansion ratio is 10.8. The exact time at which ½ of the area is burning is a little subjective to within 15 seconds or so. All tub test results should include the expectation of an error bar of 15 seconds. These examples also show that the organic solvent can be excluded, thus reducing the flammable content and making it more environmentally friendly.

The next tub test examples are identical except contain sulfuric acid (SA) and Makon DA4 was used. The ratio of SA to Makon DA4 was chosen as 72 g to 203 g, 87 g to 188 g, 100 g to 175 g, and 125 g to 150 g. These samples turn purple at room temperature and appear to be fully reacted and reach a temperature of 185° F. from the exothermic reaction. The composition then consists of 2200 g water, 50 g of one of four ratios of SA to Makon DA4, 5 g diutan, and then neutralized with DETA. There was no need for glycol ether to obtain good properties. For 72 g SA to 203 g of Makon DA4, the extinguishment time in the tub test was 128 seconds and the expansion ratio was 15.2. For 87 g SA to 188 g of Makon DA4, the extinguishment time was 210 seconds and the expansion ratio was 9.76. For 100 g SA to 175 g of Makon DA4, the extinguishment time was 135 seconds and the expansion ratio was 10.3. For 125 g SA to 150 g of Makon DA4, the extinguishment time was 120 seconds and the expansion ratio was 9.6. The best result is for 87, 188 and quite unexpected. Similar results were found with Makon UD5 substituted for Makon DA4.

The results indicate that extinguishment time of RF3 control of 115 seconds is comparable to or less than many of our examples with SA. The expansion ratio of RF3 tends to be less than our examples. It is surprising that the SA/ethoxylated alcohol/diutan/DETA form FFF that are effective over a wide compositional range. These results were unexpected. We are not aware of ethoxylated sulfate esters being made over a wide compositional range. SLES is made with an ethoxylated lauryl alcohol with one or two EO's. The bonding of our compositions is unexplained except that we observed foam with fire fighting capability over a wide compositional range.

In the next examples, the ratio of PPA to Makon DA4 was chosen as 72 g to 203 g, 87 g to 188 g, 100 g to 175 g, and 125 g to 150 g. The composition then consists of 2200 g water, 50 g of one of four ratios of PPA to Makon DA4, 5 g diutan, and then neutralized with DETA. No glycol ether was used. These samples turn a slight tan color at room temperature and do not appear to be fully reacted. We heated these samples to 400° F. to make sure of complete reaction. For 72 g PPA to 203 g of Makon DA4, the tub test extinguishment time was 135 seconds and the expansion ratio was 7.10. For 87 g PPA to 188 g of Makon DA4, the extinguishment time was 195 seconds and the expansion ratio was 10.16. For 100 g PPA to 175 g of Makon DA4, the extinguishment time was 120 seconds and the expansion ratio was 8.4. For 125 g PPA to 150 g of Makon DA4, the tub test extinguishment time was 104 seconds and the expansion ratio was 11.54.

This tub test shows that FFF foam from sulfuric acid, DETA, ethoxylated alcohol, and a thickener provide preferred fire fighting foam compositions. Nearly as good performance can be made with PPA substituted for SA.

The 1 sq ft test is the quickest test and does show possible compositions and their expansion ratios. This test does not address whether the foam will have good burnback. The tub test distinguishes burnback behavior and showed that a thickener is necessary to obtain good burnback behavior. These tests show that addition of PNS to FFF is not as effective in burnback resistance as adding PNS-F to FFF. These tests further show that foam made with PNS and SLES is not as effective as PNS-F in burnback resistance. Foam made with PNS and SLES has inferior expansion ratio to that made with PNS-F using a MILSPEC nozzle. Foam made with PNS added to FFF has inferior expansion ratio to that made with PNS-F using a MILSPEC nozzle. Our data consistently shows that foam made with PNS-F has superior expansion ratio to Solberg RF3. PNS-F made with PPA and EA self intumeses. PNS-F made with SA and EA does not self intumesce as well as the PPA-EA derived PNS-F. A combination of using both SA for viscosity and PPA for self intumescense may be the more preferred.

It appears that diutan Gum is more effective that xanthan and likely a result of higher mw of diutan gum as compared to xanthan gum. A literature search on google indicates that the molecular weight (mw) of diutan gum is 1,000,000 g/mole and only 933 g/mole for xanthan gum which is probable reason for the success of diutan.

Diutan and xanthan are both used in drilling fluids. A search in google indicates the following. Xanthan gum is commonly used in drilling fluids to provide viscosity, solid suspension, and fluid-loss control. However, xanthan is sensitive to high temperatures and not tolerant of field contaminants. Diutan gum offers the same functions but overcomes the deficiencies of xanthan gum. The higher temperature resistance of diutan would be of great importance for backburn resistance and burn through resistance where the foam blanket needs to resist very high temperature.

CP Kelco Co. shared the following unpublished information. CP Kelco supplies both xanthan and diutan. CP Kelco says their Xanthan gum has a MW of about 2 million Daltons and Diutan gum has a MW of about 2.85-5.2 million Daltons. CP Kelco indicates that Diutan gum is actually a much longer molecule than xanthan because most of its molecular weight (⅔) is in the backbone of the molecule making it longer versus xanthan gum with has ⅗ of its MW in the side chains—so xanthan is bulkier and shorter than Diutan gum. CP Kelco bases their analysis on AFM (Atomic Force Microscopy) which has shown that the Diutan molecule is about 4-5× longer than the xanthan molecule. CP Kelco believes that a higher molecular weight biogum should provide better foam stabilization than a lower molecular weight biogum at the same concentration.

Makon DA4 is a c10 isodecyl alcohol with molecular weight 158. Addition of 4EO makes the molecular weight of Makon DA4 about 324. Thus, the reaction for 87 SA, 188 Makon DA4, and DETA, involves 0.16 moles SA, 0.11 moles Makon DA4, and 0.13 moles DETA which has a valence of 2 the same as SA. There is no way to justify these molar ratios. There seems to be a substantial reaction of SA and DETA occurring which results in a flame retardant. The formulation contained 0.18 moles PPA, 0.11 m Makon DA4, 0.14 moles DETA as well as a small amount of diutan. The ratios are similar to that for SA, Makon DA4, DETA, and diutan. The ratios of reactants cannot be justified on the basis of formation of traditional ester bonds as is thought to occur in compounds such as SLES. Furthermore, similar properties are observed for both SA and PPA with ratio of acid to ethoxylated alcohol varying widely. We have been able to avoid the use of glycol ether so as to reduce the amount of flammable ingredients. Organic solvents are not good for the environment. The very high molecular weight diutan gum holds the ingredients together despite the heat and flames. The foam solution has the consistency of soap concentrate due to the thickener.

The 1 sq ft test and the tub test are helpful but do not address whether the foam will spread quickly on large tank fires to form a foam blanket. It is necessary to do a few 28 sq ft tests to choose the best performing composition. We will find that spraying these foam compositions on large gas fires puts out the fire even though spreads slowly.

In Spraying Systems Company and Teejet Company literature, it is stated that hollow cone nozzles produce the smallest average drop size of any purely hydraulic nozzle. Axial hollow cone nozzles produce the smallest droplet size of any hollow come nozzle. Only, hollow cone nozzles that spray a fine mist will be used here. The Teejet literature says that creation of a fine mist spray means that the droplets can be absorbed quicker, cool quicker, and moisturize the best. These three properties are ideal for the fire fighting foam application addressed here.

Hollow cone nozzles can be simple or quite complex. Lechler corporation provides hollow cone nozzles that contain spiral grooves that swirl liquid before exiting and are very expensive. Spraying Systems Co. provides expensive hollow cone axial flow nozzles where the liquid passes through slots as it whirls in a circular route. Teejet makes a much simpler inexpensive hollow cone nozzle (Conejet Visio Flow Hollow Cone Spray Tip) consisting of an easily removable insert that blocks the liquid from passing directly through the nozzle. these nozzles with a simple design are very inexpensive and light weight compared to the nozzles that swirl the liquid. The Teejet nozzles work the best for our fire fighting foam application.

The best samples from the tub test will now be repeated for 28sq ft test with 4 gallons E10 gasoline. The test was first done with a MILSPEC nozzle spraying a single stream of foam as outlined in the protocol. The CA-PPA foam (150 g PPA, 150 g Makon UD5, 13200 g H2O, 33 g xanthan, 48 g glycol ether) and CA-SA (150 g SA, 150 g Makon UD5, 13200 g H2O, 33 g xanthan, 48 g glycol ether) foam behaved similarly with the MILSPEC nozzle spraying a single stream. The extinction times ranged from 60 seconds to 80 seconds when spraying a single stream. The foam does not spread out quickly out and it takes a long time to form a blanket of foam sealing the surface of gasoline. It seems unlikely that the gasoline fire can be extinguished with a single stream in 30 seconds which is the goal for the MILSPEC test. The foam itself seems quite stable and forms a good blanket. There is just a lack of spreading quickly as does AFFF foam.

We will now try to achieve the 30 second goal by spraying the foam with a boom with attached hollow cone nozzles and arranged to give a large footprint so that the surface of the tank is covered in seconds. The boom will contain 7-12 hollow cone nozzles. The boom will be attached to a Torq foam cannon which is connected to a telescoping wand which is connected to a 50 foot ⅜″ hose powered by a pressure washer. A feed tank containing the foam solution pressurized to 50 PSI was connected to the pressure washer intake line. The foam solution from the tank is propelled through a 50 ft hose through the wand through the foam cannon and then through the boom and expelled through the hollow cone nozzles as a fine mist. The pressure at the individual nozzle was measured to be about 65 PSI.

A copper fitting with male ¾ inch thread is welded to the Torq foam cannon. A boom is attached in the shape of a rectangle 11″ on one side and 7″ on the other. On each corner is attached a triangle (5″ base and 5″ height) of three hollow cone nozzles. The boon is attached to a telescoping wand so that the fire can be fought at a distance of at least 10 feet. The fine mist is formed by 12 Teejet Conejet TX-12 nozzles. The solution was made from 13,200 g water, 150 g SA 98% concentration reacted with 150 g Makon UD5, 33 g xanthan, 48 g glycol ether, and about 145 g DETA to obtain a pH near 7.0. Thus this sample contains (145+150) FR and 150 g surfactant. The approximately 14 L of solution was placed in a tank held at a pressure of 50 PSI and attached to a pressure washer. The 4 gallons of E10 gasoline was placed in a 28 sq ft round tank containing one inch of water and ignited. The above described apparatus forms a spray that looks like a mist and acts like a mist. The wand with foam cannon/boom is applied in a circular motion going around the tank rim. The fire was extinguished in 15 to 22 seconds over 4 trials, well before a continuous foam blanket formed. The mist sprayed as a large footprint accumulates on the surface as a partial foam barrier. We believe that the high surface area mist is both cooling the flame and reacting with the radicals in the fire. It is really important to spray the sides of the tank where re-ignition occurs due to the hot metal tank side. Fifteen seconds is too short time a time to form a continuous foam blanket with foam with poor spreading coefficient. After the fire is over, a film forms on the surface as well as foam over much of the tank. Similar results are found for mix of 6 Teejet Conejet TX-12 and 6 TX-10 nozzles or 12 Teejet Conejet TX-18 nozzles. Some char was observed on the surface after the gasoline fire was extinguished as well as a continuous film/coating. The pressure at one nozzle was measured to be 65 PSI. The PSI gets reduced by the diversion wire mesh pellet. The pressure is distributed over 12 nozzles and becomes only 65 PSI when spraying water.

Substitution of flat spray nozzles resulted in extinction times greater than 30 seconds. The flat spray nozzles hit the gasoline surface with much higher impact making large waves, and making fire extinguishment more difficult due to re ignition.

The solution made from 13,200 g water, 150 g SA 98% concentration reacted with 150 g Makon UD5, 33 g xanthan, 48 g glycol ether, 145 g DETA and a pH equal to 7.0 extinguished a 4 gallon E10 gasoline fire in 15.8 seconds. The fire is about 40 feet in height initially and nothing is visible on the other side of the fire. At 7.5 seconds, the fire is about 5 feet high, occupies about ½ of the tank, and the other side of the fire is visible. At 11 seconds, about 90% of the fire is extinguished. At 14 seconds, a tiny amount of flames on one edge still exist. The foam has formed a thin blanket on about ½ of the 28 sq ft tank. The conclusion has to be that the foam in the form of a mist formed with misting hollow cone nozzles has cooled the fire so that there is no backburn danger. The fire is knocked down so quickly has to be partially from reaction with radicals and cooling. Cooling the fire also diminishes radicals and thereby the flame quickly. These tests are too difficult and costly to do a careful study of the different parameters. We have to rely on simple tests such as the 1 sq ft test and the tub test to choose the best compositions.

Similar results are found using a solution made from 13,200 g water, 150 g PPA 115% reacted with 150 g Makon UD5, 33 g xanthan, 48 g glycol ether, and about 140 g to 150 g DETA to obtain a pH near 7.0. The PPA version has more char on the surface after the fire than does the SA version. The SA reaction with Makon UD5 is carried out at room temperature and forms a hot purple solution with foam bubbles on the surface and some smell. The PPA reaction with Makon UD5 is carried out at 400° F. The PPA-Makon UD5 product solution cools to a very viscous state that is difficult to dissolve in water. The SA-Makon UD5 pours easily at room temperature and dissolves readily in water, a big advantage in forming a concentrate. The low viscosity is a general property of SA reacted with complex alkyl compounds.

Similar results were found using 225 g UD5 reacted with 75 g SA or 75 g PPA and then reacted with approximately 70 g DETA. Similar results were found using 200 g UD5 reacted with 100 g SA or 100 g PPA and then reacted with approximately 90 g-95 g DETA. The 1 sq ft and tub tests indicate that the thermal stability is better as the ratio of acid to UD5 increase which is important for really large fires.

The fire goes out even though the foam blanket is not continuous. The fire goes out quickly if we spray the outer metal wall of the tank going round and round. The spray rate was measured to be 2.5 GPM. The expansion ratio is found to consistently be about 5.5 to 6.5 and even as high as 8.5 depending on the nozzle and the size of the boom and the ratio of complex alkyl to acid. It was unexpected that the hollow cone nozzles form foam that comes out as a fine mist that is efficient in cooling and can react with the flame. It was really unexpected that a foam with expansion ratio greater than 5.0 is consistently obtained.

Now we report two tests for the 28 sq ft fuel tank fires with 10 gallons E0 gasoline and 1 inch of water conducted at the NRL fire test center at Chesapeake, Md. The test followed the official MILSPEC test protocols with 10 gallons of E0 gas with one modification. Instead of the MILSPEC nozzle, the foam was made and applied with a pressure washer to which was connected the TORQ foam cannon and boom of 12 Conejet Visio Flow Hollow Cone Spray Tip nozzles TX-26 as previously described. The first solution tested was formed from 26,400 g H2O, 60 g xanthan, 96 g glycol ether EB, and 200 g PPA reacted with 400 g Makon UD5, and then reacted with DETA to have a pH near 7.0. The expansion ratio was approximately 8. The time to extinction was 31 seconds, very close to the AFFF MILSPEC requirement of 30 seconds. The backburn time was found to be greater than 12 minutes where the test requirement is only 360 seconds. The second FFF solution tested was formed from 26,400 g H2O, 60 g xanthan, 96 g glycol ether EB, and 250 g sulfuric acid 98% reacted with 350 g Makon UD5, and then reacted with DETA to have a pH near 7.0. The expansion ratio was approximately 8. The time to extinction was 35 seconds, very close to the AFFF MILSPEC requirement of 30 seconds. The backburn time was found to be greater than 12 minutes. The backburn test was stopped at 12 minutes, because the gasoline fuel in the pan was used up. The pan fire did not ignite over the tank. The chief test supervisor at NRL indicated the backburn behavior was the best ever measured in their test lab and exceeded the backburn behavior obtained for AFFF. Also, the extinction times of 31 and 35 seconds is much better the 55 seconds or more normally observed at this test site for FFF made by other companies. The excellent backburn behavior is attributed to the use of PNS-F having inherent flame retardant properties resulting in better thermal stability. The flame retardant property should correlate with better thermal stability as measured in the gas grill testing. The better thermal stability should result in foam that does not collapse readily and helps lower extinction time. These results confirm that spraying mist derived from PNS-F with a large footprint overcomes inherent poor spreading coefficient of FFF. The results with using PPA or sulfuric acid are comparable. The operator found it was necessary to move the mist spray rapidly about the tank to get am evenly applied foam blanket. This test with 10 gallons of E0 gasoline required almost full blanket to form and extinguish the fire. The mist appeared to cool the fire rapidly as the heat felt at a distance of 30 feet subsided very rapidly after about the initial 15 seconds. These compositions serve as a guideline. A person knowledgeable in FFF will figure out how to improve overall behavior by lessoning the burnback property and decreasing the time to extinction. For example, probably the amount of thickener can be decreased.

When the first solution was applied to a fire with a MILSPEC nozzle as single stream, the test was abandoned at 30 seconds. It was obvious that the extinction would not be close to the 31 seconds or 35 seconds obtained with the identical FFF solution. This result shows further the power of a large footprint application with misting nozzle as compared to single stream. The difficulty in applying the foam as a mist is the reduction of expansion ratio due to wire mesh and hollow cone misting nozzles. The superior foaming ability of PNS-F enables its use as a mist of foam.

It is possible that experts in the field of FFF will know how to incorporate or substitute PNS-F into the cocktail of chemicals forming FFF. Possibly incorporation of siloxane surfactants could aid spreading but at the expense of other properties. These were unexpected properties of PNS-F foam that it could form such an effective mist foam droplets.

Teflon like compounds conducts heat really well. We expect that AFFF foam that contains Teflon like compounds will conduct heat more readily than the PNS-F compounds that intumesce when subjected to heat. PNS-F compounds could result in better performing foams than AFFF if it were not for the poor spreading coefficient of PNS-F foams compared to AFFF. However, applying with a large footprint overcomes this problem.

The boon was attached to the MILSPEC nozzle. Unfortunately, the solution backs up and does not form foam. It will be necessary to modify the dispersal cone in the MILSPEC nozzle to resemble the dispersal wire mesh tablet of the foam cannon. Then, the MILSPEC nozzle with boom attached could be used in the testing of FFF on fuel tank fires and provide a large footprint. Our results indicate that the performance of FFF requires a large footprint application.

We found that hollow cone nozzles result in a fine mist of foam that impacts the surface of a tank more gently than does flat fan nozzles or single stream spraying. Thus, for a gasoline tank fire, less splashing of the surface is found with fine mist hollow cone nozzles. Cooling provided by the fine mist of the hollow cone enables quicker extinguishing of liquid fuel fires. It was unexpected that the fine mist nozzles did not collapse the foam bubbles but made a foam of small bubbles and the expansion ratio still exceeded 5 which is a MILSPEC test requirement. The fine mist reacts with radicals in the flame as well as cools the flame.

Many types of tests have been done with the goal of passing the MILSPEC test without the use of fluorinated compounds. The choice of preferred compositions will be guided by the results of the 28 sq ft test with 10 gallons of gasoline. The ratio by weight of Makon DA 4 or Makon UD 5 to PPA or SA from 250/50 to 150/150 is preferred, and more preferred is 225/75 to 175/125. It is preferred to react with the EA being DETA. We claim such compositions should be capable of having MILSPEC burn times less than 40 seconds and backburn greater than 360 seconds if conducted with a boom of hollow cone nozzles. The preferred is subject to change as different amounts of ethoxylation of alcohol and different ethoxylated alcohols are investigated. It appears that alcohols ethoxylated with EO=4 is similar to EO=5. It is likely that a Makon UD2 and Makon UD3 (EO 2 and 3) might be helpful but a commercial source has not been found. Similar compositions are expected for other ethoxylated alcohols. This range has only been investigated for the gasoline fire fighting foam application. The preferred may change for other fuels such as diesel, for wildfires, and for polymers. More generally for all uses, the ratio by weight of the complex alkyl compound to the acid is at least 0.01 but less than 20 and reacted with the ethyleneamine DETA.

This test shows that FFF foam from polyphosphoric acid or sulfuric acid (SA), DETA, ethoxylated alcohol, and a thickener provide preferred fire fighting foam compositions without the necessity of including an organic solvent such as glycol ether. Companies such as Stepan that supply the ethoxylated alcohols Makon DA series and Makon UD series also furnish thickeners that are compatible with liquid detergents. Liquid detergents are concentrated in that a consumer adds water that easily mixes in with the detergent. These thickeners probably will be suitable with our formulations. For example there are: BiosoftTA2 is a tallow amine ethoxylate, Stepan Mild GCC is a glycerol caprylate/caprate made by esterification of glycerin from vegetable sources, AMPHOSOL CS-50, cocamidopropyl hydroxysultaine, is an amphoteric surfactant that can be used as a secondary surfactant providing foam boosting and viscosity building and the list is very long of other available products. There are other companies with new thickeners compatible with surfactants. All of these are candidates to replace diutan and xanthan or to be used in combination for the particular application of fire fighting foams.

Complex alkyl polyphosphate solution (CA-PPA) or complex alkyl sulfate solution is formed by the reaction of a complex alkyl compound and polyphosphoric acid or sulfuric acid done at a temperature that enables the reaction to form a solution and the ratio by weight of complex alkyl to acid is at least 0.01 but less than 20. The formation of the complex alkyl polyphosphate solution requires PPA and a complex alky to be reacted to form a solution which has a little color but is transparent in film form. Heat speeds up the reaction rate and is necessary to extract the product which can be quite viscous for compositions that are primarily EAPPA. It has been found convenient to use a temperature of 400° F. It is possible that lower temperatures or even without heating may be possible for some complex alkyl compounds. One knowledgeable in this chemistry can start with no heat and then adjust heat to find the best balance of temperature with time to full solution formation and good viscosity to extract composition from reactor. The disadvantage of using little or no heat is that it takes much longer for the reaction to proceed to completion and can be extremely difficult to extract product. No heat has been found acceptable for making CA-SA compositions rapidly with acceptable flow behavior. The performance of CA-PPA and CA-SA as fire extinguishing foam is similar. PPA is a weaker acid and more environmentally friendly. Considerations and preferred compositions for complex alkyl reacted with phosphoric acid or sulfonic acid will be similar. The required fire testing is so demanding that phosphoric acid and sulfonic acid were not maybe. We have every reason to expect these two acids will result in good performing foams.

The preferred fatty alcohols and ethoxylated alcohols of CA-PPA, CA-PA, CA-SA, CASE-PPA, and CAPE-PPA solutions have 8 to 18 carbon atoms, more preferred is 9 to 15, and most preferred is 8 to 11 carbon atoms. The degree of ethoxylation depends on the application. The pH of CA-PPA, CA-PA, CA-SA, CASE-PPA, and CAPE-PPA solutions at 10% concentration by weight in water is preferred to be less than 2, more preferred is less than 1.9, and most preferred is less than 1.8 which distinguishes this product from the commercial complex alkyl phosphate ester with a pH usually above 2-2.5. In all examples in this specification the solutions are reacted with DETA unless specifically indicated otherwise. It is also possible to overlook an ingredients when giving the details of so many different examples in this specification.

There are three primary areas of application: wildfire, foam for fuel fires especially fuel tank fires, and polymers. For class A fires, it has been shown in application pct/us20/52061, that a mist of PNS is effective in combating the flames of class A fires by spraying into the flames or coating the fuel in front of the fires. As foam compositions have soap properties of encapsulation or as a wetting agent that increases sticking to fuel. The goal is to add some surfactant behavior to PNS, thus creating PNS doped with a foaming agent. That is accomplished by adjusting the ratio of complex alkyl to PPA in formation of the complex alkyl polyphosphate (CA-PPA) solution. For class A fires, the ratio of complex alkyl to PPA by weight is less than 0.6, more preferred is less 0.35, and most preferred is less than 0.15 but greater than 0.01. Such a ratio means that the composition is primarily PNS doped with a small amount of ethyleneamine complex alkyl polyphosphate solution. The purpose of complex alkyl is to add surfactant behavior to more effectively coat the fuel with this formulation of PNS-F. Depending on the situation and fire size, it might be preferred to spray a mist onto the fuel in front of the fire or near the fire. For class A, it is preferred that the aqueous concentration be at least 15%, more preferred concentration at least 25%, and most preferred at least 35%. For the class A application, ethyleneamines reacted with CA-PPA or CA-PA are preferred. More preferred is ethyleneamines reacted with CA-PPA. The preferred ethoxylation is 2 to 12, more preferred is 4 to 12, and most preferred is 4 to 10.

The surfactants and their foam solutions formed from ethyleneamine complex alkyl polyphosphate solution composition or ethyleneamine complex alkyl sulfate solution is known to be stable in solutions containing sodium chloride. Thus, FFF can be made with these new surfactants in either water or sea water.

The principal component of purple K fire extinguishing powder is potassium bicarbonate (78-82% by weight). It is expected that our FFF will be compatible with purple K because of its tolerance to sodium and potassium chloride salts.

U.S. Pat. Nos. 713,844 and 10,501,602 show that DETAPPA can be formed in solutions containing substantial sodium chloride. Thus, the new PNS-F surfactants should also be stable in sodium chloride solutions. As a result, the FFF foam made with PNS-F is usable with well water or sea water. All examples use well water that is contaminated with minerals and some dirt.

For class B flammable liquid fires, the FFF containing ethyleneamine complex alkyl polyphosphate solution composition or ethyleneamine complex alkyl sulfate solution is sprayed into the flames to accumulate on the surface to form a partial blanket that helps stop the fire and that provides burnback. The ratio of complex alkyl to PPA or SA is chosen to provide a foaming composition with some flame retardation behavior. For ethyleneamine complex alkyl polyphosphate solution, the ratio of complex alkyl to PPA or SA by weight is more than 0.2, more preferred is more than 0.5, and most preferred is more than 0.8 but less than 20.0. The preferred pH is 4 to 9, more preferred is 5.5 to 8.5, and the most preferred is 6.5 to 7.7. It is preferred that the foam have expansion ratio of at least 3, more preferred is at least 5.0, and most preferred is at least 6.0 but less than 10.5. The preferred ethoxylation is 3 to 12, more preferred is 4 to 10, and most preferred is 5 to 9. The expansion is different depends on the equipment doing the foaming.

Compositions that perform well in the 1 sq ft and tub test do not necessarily perform adequately at 28 sq ft and 4 gallons of gasoline. Doing well at 4 gallons gasoline in 28 sq ft test does not necessarily indicate success at 10 gallons gasoline or in even larger fires such as 50 sq ft or 400 sq ft . But poor results at 1 sq ft or the tub test is a strong indicator that there is no point in testing at larger tests. Thus, the preferred compositional ranges defined here may narrow as the tests become more severe. Thus, the preferred ranges are likely to narrow. The ability to withstand burn through and enable burn back protection probably can only be tested in a real large fire scenario.

The considerations are different for flame retarding polymers. It is important to use PPA that has been condensed to high molecular weight before making the complex alkyl polyphosphate solution. Then, react ethyleneamine with the complex alkyl polyphosphate solution (CA-PPA). Another option is to form the ethyleneamine complex alkyl polyphosphate solution and then condense to a high molecular weight form.

The preferred composition for flame retarding polymers is addition of anhydrous ethyleneamine complex alkyl polyphosphate composition. The ratio of complex alkyl to PPA by weight is preferred to be at least 0.01 but less than 20, more preferred is 0.07 to 1.7, and most preferred is. 10 to 1.4. The range is not very narrow as different polymers have such different properties, for example thermal stability. Some applications in wire and cable require much moisture resistance. The preferred pH is 4 to 7.5, more preferred is 5.5 to 7.5, and the most preferred is 5.5 to 7. The purpose of complex alkyl is to add moisture resistance which depends on the polymer and the application. The ethoxylation has a big impact on moisture resistance. The preferred ethoxylation is zero to 12, more preferred is zero to 6, and most preferred is zero to 3. Zero means no ethoxylation with DETA (LP-PPA) being an example.

For all synthesis situations, as the degree of ethoxylation increases, the reaction between PPA and the ethoxylated alcohol becomes easier and a lower temperature can be used to form complex alkyl polyphosphate solution. Thus, a temperature of 100° F. to 450° F. should cover all situations, with 200° F. to 400° F. being more preferred, and 300° F. to 400° F. being most preferred to facilitate the reaction between PPA 115% and complex alkyl compounds and to easily extract the product from the mixer. The use of lower molecular weight PPA would lower the preferred temperature ranges at which reaction is facilitated. The reaction parameters should be similar for the formation of complex alkyl phosphate solution. The term complex alkyl compounds covers both ethoxylated and unethoxylated compounds.

For polymer applications, the reaction should be carried out without solvent or water. This process forms the flame retarded composition to be added to polymers in one synthesis. The reaction temperature is such that the reaction of the acidic compounds with EA goes to completion and the product can be extracted. It is preferred to use only condensed polyphosphoric as high molecular weight is essential in making CA-PPA suitable for polymers. Condensation is essential to reduce the amount of phosphoric acid and thereby make the product as thermally stable as possible.

We claim:

1. A chemical precursor solution, comprising a chemical precursor solution 1 and a chemical precursor solution 2, wherein the chemical precursor solution 1 is formed by a reaction of a complex alkyl compound with an acid chosen from a group comprising polyphosphoric acid (PPA), phosphoric acid, sulfuric acid, and sulfonic acid, and a ratio by weight of the complex alkyl compound to the acid is at least 0.01 but less than 20; the chemical precursor solution 2 is formed by a reaction of complex alkyl sulfate ester or complex alkyl phosphate ester with the polyphosphoric acid, and a ratio by weight of the complex alkyl sulfate ester or the complex alkyl phosphate ester to the polyphosphoric acid is at least 0.01 but less than 20; and the complex alkyl compound is chosen from a group comprising ethoxylated fatty alcohols, fatty alcohols, alcohols, ethoxylated alcohols, ethoxylated phenol, ethoxylated alkylphenol, alkyl polyglycoside, and alkyl aryl.

2. The chemical precursor solution according to claim 1, wherein a reaction to form the chemical precursor solution according to claim 1 is performed at a temperature between room temperature to 400° F., the polyphosphoric acid has a grade from 105% to 118%, concentrations of the phosphoric acid and the sulfuric acid are each at least 80%, and 10% chemical precursor solution in water has a pH of less than 2.2.

3. The chemical precursor solution according to claim 1, wherein 10% chemical precursor solution in water has a pH of less than 2.0.

4. A surfactant composition, wherein the surfactant composition is formed by a reaction of one or more compounds chosen from a group comprising ethyleneamine, alkali metals, ammonia, and alkanolamines with 1) one or more of the chemical precursor solution according to claims 1, and 2) with one or more compounds chosen from a group comprising complex alkyl phosphate ester, complex alkyl sulfate ester, and complex alkyl sulfonate ester, and 10% by weight of the surfactant composition in water or in water and organic solvent has a pH of at least 3.5 and less than 8.5.

5. The surfactant composition according to claim 4, wherein the ethyleneamine is chosen from a group comprising ethylenediamine (EDA), diethylenetriamine (DETA), piperazine (PIP), triethylenetetramine (TETA), tetraethylenepentamine (TEPA), and pentaethylenehexamine (PEHA); and the complex alkyl ester is chosen from a group comprising fatty alcohol phosphate ester, ethoxylated fatty alcohol phosphate ester, fatty alcohol sulfonate, fatty alcohol sulfate ester, and ethoxylated fatty alcohol sulfate ester and the solution is chosen from a group comprising fatty alcohol phosphate solution, ethoxylated fatty alcohol phosphate solution, fatty alcohol polyphosphate solution, ethoxylated fatty alcohol polyphosphate solution, fatty alcohol sulfonate, fatty alcohol sulfate solution, and ethoxylated fatty alcohol sulfate solution, wherein, the ethoxylated fatty alcohol or fatty alcohol has 8 to 18 carbon atoms.

6. A surfactant solution, wherein the surfactant solution is formed 1) by dissolving the surfactant composition according to claim 4 in water or in mixed water and organic solvent, a concentration of the surfactant composition being at least 1% by weight of the surfactant solution; or 2) by dissolving the chemical precursor solution according to claim 1 in water or in mixed water and organic solvent and then reacting the chemical precursor solution 1 or the chemical precursor solution 2 with one or more compounds chosen from a group comprising ethyleneamine, alkali metals, ammonia, and alkanolamines with a concentration of a resulting solution being at least 1% by weight of the surfactant solution.

7. The surfactant solution according to claim 6, wherein the ethyleneamine is chosen from a group comprising ethylenediamine (EDA), diethylenetriamine (DETA), piperazine (PIP), triethylenetetramine (TETA), tetraethylenepentamine (TEPA), and pentaethylenehexamine (PEHA); and the ester is chosen from a group comprising fatty alcohol phosphate ester, ethoxylated fatty alcohol phosphate ester, fatty alcohol sulfonate, fatty alcohol sulfate ester, and ethoxylated fatty alcohol sulfate ester and the chemical precursor solution is chosen from a group comprising fatty alcohol phosphate solution, ethoxylated fatty alcohol phosphate solution, fatty alcohol polyphosphate solution, ethoxylated fatty alcohol polyphosphate solution, fatty alcohol sulfonate solution, fatty alcohol sulfate solution, and ethoxylated fatty alcohol sulfate solution, wherein, the ethoxylated fatty alcohol or fatty alcohol has 8 to 18 carbon atoms.

8. A fluorine free foam (FFF) composition comprising water and the surfactant solution according to claim 6 or 7, wherein a pH of the fluorine free foam solution is at least 5.5 and less than 8.5.

9. The fluorine free foam composition according to claim 8, additionally containing 0.1% to 4% by weight of a thickener chosen from a group comprising fumed silica, xanthan gum, diutan, scleroglucan, heteropolysaccharide, locust bean gum, partially-hydrolyzed starch, and guar gum; and additionally containing 0.1% to 4% by weight of an organic solvent.

10. The fluorine free foam composition according to claim 9, wherein the organic solvent is glycol ether selected from a group comprising ethylene glycol monomethyl ether, ethylene glycol monoethyl ether, ethylene glycol monopropyl ether, ethylene glycol monobutyl ether, ethylene glycol monohexyl ether, ethylene glycol phenyl ether, diethylene glycol methyl ether, diethylene glycol monoethyl ether, diethylene glycol monopropyl ether, diethylene glycol monobutyl ether, diethylene glycol monohexyl ether, triethylene glycol monomethyl ether, and triethylene glycol monoethyl ether; and the organic solvent comprises any of propylene oxide based materials.

11. The fluorine free foam composition according to claim 10, wherein the propylene oxide based material is selected from one or more of propylene glycol monomethyl ether, propylene glycol monopropyl ether, propylene glycol monobutyl ether, propylene glycol t-butyl ether, propylene glycol phenyl ether, dipropylene glycol monomethyl ether, dipropylene glycol monopropyl ether, dipropylene glycol monobutyl ether, dipropylene glycol dimethyl ether, tripropylene glycol methyl ether, tripropylene glycol n-butyl ether, propylene glycol methyl ether acetate, and dipropylene glycol methyl ether acetate.

12. The fluorine free foam composition according to any one of claims 8-11, having the property foaming agent and flame retardance if the compound chosen to react with the acid is ethyleneamine.

13. A mixture of a surfactant with ethyleneamine polyphosphate (EAPPA), wherein the surfactant is the surfactant composition according to claim 4 or 5, the surfactant solution according to claim 6 or 7, or the fluorine free foam composition according to any one of claims 8-12, and the amount of the ethyleneamine polyphosphate is from 1% to 99% by weight of the mixture.

14. An aqueous fire extinguishing fluorine free foam (FFF) in the form of a mist, comprising the fluorine free foam composition of any one of claims 8-12, the aqueous fire extinguishing fluorine free foam having a expansion ratio greater than 2 but less than 20 and a water content being at least 45% but less than 99%, wherein the mist consists of droplets with a volume median diameter less than 1500 micron, or less than 600 micron, or less than 400 micron, or less than 200 micron, or less than 75 microns.

15. The aqueous fire extinguishing fluorine free foam according to claim 14, wherein the mist is delivered by a system comprising a Venturi type foam former with at least one boom with at least two nozzles where the boom is projected into flames and operating variables of the system and composition of the aqueous fire extinguishing fluorine free foam are such to discharge the mist of the aqueous fire extinguishing fluorine free foam with expansion ratio of at least 3.

16. The aqueous fire extinguishing fluorine free foam according to claim 15, wherein the expansion ratio is at least 5 and the foam is made with either water or sea water.

17. The aqueous fire extinguishing fluorine free foam according to claim 16, wherein the mist is discharged by a boom configured to cover an area of at least 25% of a surface area of a fire.

18. The aqueous fire extinguishing fluorine free foam according to any one of claims 14-17, wherein the aqueous fire extinguishing fluorine free foam in the form of a mist has the properties of cooling the flames and reacting with the flame plasma radicals and ions.

19. An aqueous fire extinguishing fluorine free foam that has burn time less than 40 seconds and backburn time greater than 360 seconds for the 28 sq ft round tank test with 10 gallons alcohol free gas with the composition of 27,400 g H2O, 60 g thickener, 96 g glycol ether, and PPA or sulfuric acid reacted with ethoxylated alcohol at a ratio from 50 g acid to 250 g ethoxylated alcohol to 150 g acid to 150 g ethoxylated alcohol.

20. The foam in claim 15 is generated by a Venturi type foam educator and the pressure applied to the educator is such that the pressure at the foam nozzles is at least 30 PSI, at least 50 PSI more preferred, and at least 60 PSI most preferred.
